(19) United States
(12) Patent Application Publication
(10) Pub. No.: US 2018/0101574 A1
(43) Pub. Date: Apr. 12, 2018

(54) SEARCHING INDEX INFORMATION FOR APPLICATION DATA

(71) Applicant: Alibaba Group Holding Limited, George Town (KY)

(72) Inventors: Bing Tang, Hangzhou (CN); Guojian Hao, Hangzhou (CN); Jianming Lai, Hangzhou (CN); Zhijun Yuan, Hangzhou (CN); Kai Wang, Beijing (CN)

(21) Appl. No.: 15/729,422

(22) Filed: Oct. 10, 2017

(30) Foreign Application Priority Data
Oct. 12, 2016 (CN) 201610892058.0

(51) Int. Cl. G06F 17/30

(52) U.S. Cl. CPC G06F 17/30477; G06F 17/30864

(57) ABSTRACT

A search method is disclosed, including obtaining, by one or more processors, query information, searching, by the one or more processors, index information based at least in part on the query information, the index information comprising information that pertains to application units, wherein the information that pertains to an application unit comprises content of the application unit and Uniform Resource Identifier of the application unit, determining, by the one or more processors, an application unit based at least in part on a search result, and running, by the one or more processors, the application unit.

### CROSS REFERENCE TO OTHER APPLICATIONS

This application claims priority to People's Republic of China Patent Application No. 201610892058.0 entitled A Search Method, Means, Terminal Device, and Operating System, filed Oct. 12, 2016, which is incorporated herein by reference for all purposes.

### FIELD OF THE INVENTION

The present application relates to the field of computing terminal technology. In particular, the present application relates to a search method, a method for building indices, a system or device for performing a search, a system or device for building indices, a terminal device, a server, and a terminal device operating system.

### BACKGROUND OF THE INVENTION

As terminal technology develops, more and more users make use of terminals, and terminals are evolving to provide an ever-increasing array of functional services. The services currently provided on terminals are provided in the form of applications (apps). The portal through which service functions are provided is generally set up on the desktop of the terminal (e.g., on the graphical user interface).

When using a terminal, a user generally searches web page content with a browser or searches application-provided information with a search function provided within the corresponding application. Application information or other information associated with an application generally cannot be searched. For example, the typical method for searching the application information or other information associated with an application is by searching among applications at application centers which specifically provide application downloading (e.g., Google® Play Store, Apple App Store, etc.). If the application has not been installed, then a user is generally required to go to an application center to install the application and to execute a verification operation such as inputting a password. Thus, each search operation within a terminal is separate, and users are required to navigate within an application providing the appropriate information in order to conduct searches. Such searching is inefficient as well as inconvenient for users.

### BRIEF DESCRIPTION OF THE DRAWINGS

Various embodiments of the invention are disclosed in the following detailed description and the accompanying drawings.

FIG. 1 is a diagram of the main framework of a context-perceiving service according to various embodiments of the present application.

FIG. 2A is a diagram of relationships among modules within a main framework of a context-perceiving service according to various embodiments of the present application.

FIG. 2B is a structural diagram of a context application framework according to various embodiments of the present application.

FIG. 2C is a life cycle diagram of a context application according to various embodiments of the present application.

FIG. 2D is a context agent engine management diagram according to various embodiments of the present application.

FIG. 2E is a structural diagram of a context application according to various embodiments of the present application.

FIG. 2F is a diagram of relationships among Pages according to various embodiments of the present application.

FIG. 2G is a diagram of transitions of a page status according to various embodiments of the present application.

FIG. 2H is another diagram of transitions of a page status according to various embodiments of the present application.

FIG. 3 is a processing diagram of a search system according to various embodiments of the present application.

FIG. 4 is a search diagram according to various embodiments of the present application.

FIG. 5 is a flowchart of a method for operation of a context-based application according to various embodiments of the present application.

FIG. 6 is a flowchart of a method for building a search index according to various embodiments of the present application.

FIG. 7 is a flowchart of a method for building a search index in a terminal according to various embodiments of the present application.

FIG. 8 is a flowchart of a method for performing a search according to various embodiments of the present application.

FIG. 9A is a diagram of a search example according to various embodiments of the present application.

FIG. 9B is a diagram of relationships between pages in a specific business service context according to various embodiments of the present application.

FIG. 10 is a diagram of a search example according to various embodiments of the present application.

FIG. 11 is a diagram of a search example corresponding to an Internet of Things system according to various embodiments of the present application.

FIG. 12 is a structural diagram of a terminal according to various embodiments of the present application.

FIG. 13 is a functional diagram of a computer system for performing a search or building an index according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the above-described objectives, features, and advantages of the present application plainer and easier to understand, the present application is explained in further detail below in light of the drawings and specific embodiments.

As used herein, a terminal generally refers to a computing device deployed (e.g., by a user) within a network system and configured to communicate with one or more servers. According to various embodiments of the present disclosure, a terminal includes components that support communication functionality. For example, a terminal can be a smart phone, a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a smart home appliance, vehicle-mounted mobile stations, or the like. A terminal can run various operating systems (e.g., IOS, Android, Cloud OS, etc.).

A terminal can have various input/output modules. For example, a terminal can have a touchscreen or other display, one or more sensors, a microphone via which sound input (e.g., speech of a user) can be input, a camera, a mouse, or other external input device connected thereto, etc.

Various embodiments are implemented in connection with Internet of Things (IOT) technology. The “Internet of Things” is a network formed by integrating the Internet with various information sensing devices such as RF identification devices, infrared sensors, global positioning systems, and laser scanners. An objective of IOT technology is to connect all things (e.g., devices) together with the Web to facilitate identification and management. In an age of universal interconnection, user devices are becoming increasingly diverse. For example, user devices include devices with screens, screenless devices, household devices, wearable devices, etc. However, in current Internet of Things technology, not every device has truly established an effective connection. To control various devices (e.g., smart devices), users thereof are generally required to navigate to the corresponding applications and select the appropriate menu functions for implementation. Accordingly, in current Internet of Things technology, numerous devices remain isolated from each other. Various embodiments create an infrastructure for context engines within a system layer. For example, various embodiments provide context sensing and context service capabilities. Various types of devices can be interconnected. The linking of devices and stringing together services provides to users a form of proactive, automated service. Thus, by directly performing searches based on architecture according to various embodiments, interconnection of devices can be improved and control can be exerted over the devices. In addition, a set of or each Internet of Things device of a user can be associated with (e.g., registered to) the user's account to achieve a form of service in which one search in connection with an account number links various application functions (e.g., across the applications and/or devices that are associated with the user's account). The user can carry out control (e.g., of one or more devices or applications associated with the user's account) that can be immediately (e.g., contemporaneously) provided directly through a search without performing a further operation on the device to enter an application page. Accordingly, inter-connectedness of devices is thus realized or improved. As an example, the Internet of things (IoT) can refer to the network of physical devices, vehicles, and other items embedded with electronics, software, sensors, actuators, and network connectivity which enable these objects to collect and exchange data.

Various embodiments provide a new application development model that expands upon conventional application models. For example, the new application model according to various embodiments provides a context engine infrastructure and context development framework within system layers. Within the system base layer, the application development model provides context perceiving capabilities and provides a reactive programming model on a dynamic language (JavaScript) foundation. Moreover, the application development model accesses (or communicates with) IOT devices using a unified protocol.

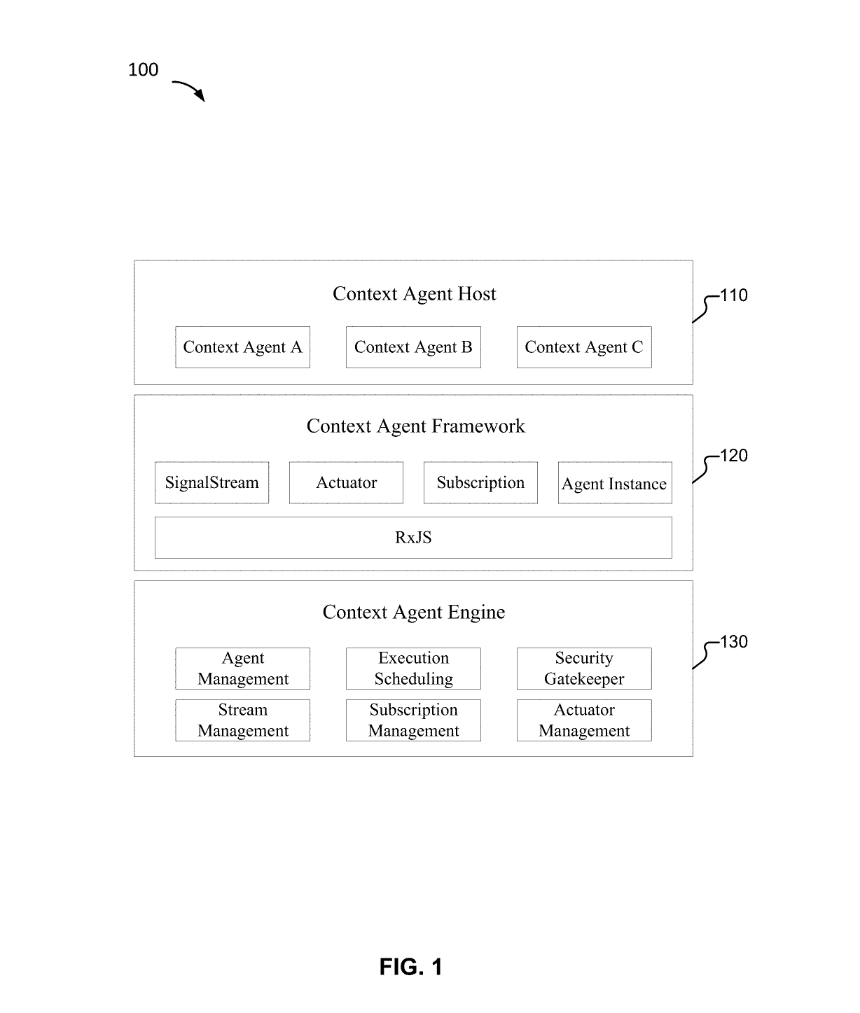

FIG. 1 is a diagram of the main framework of a context-perceiving service according to various embodiments of the present application.

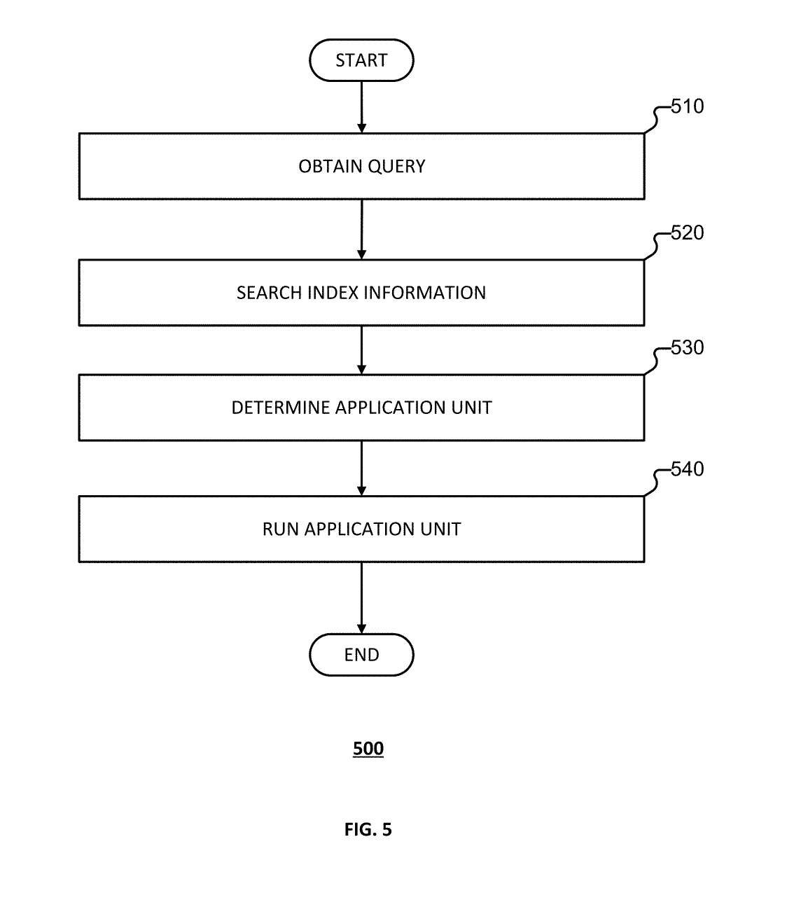

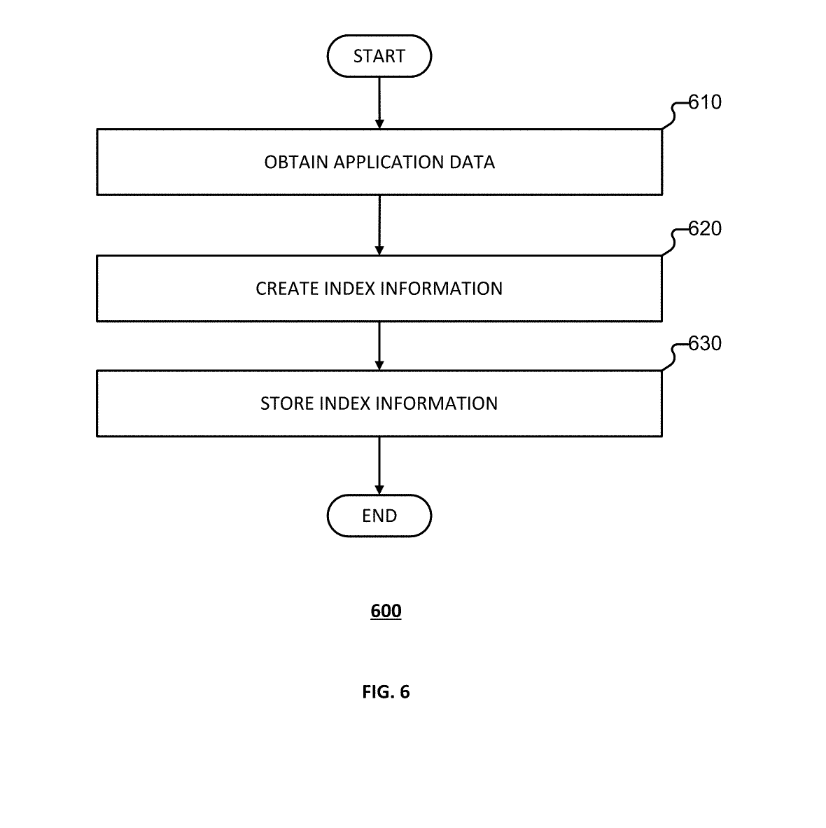

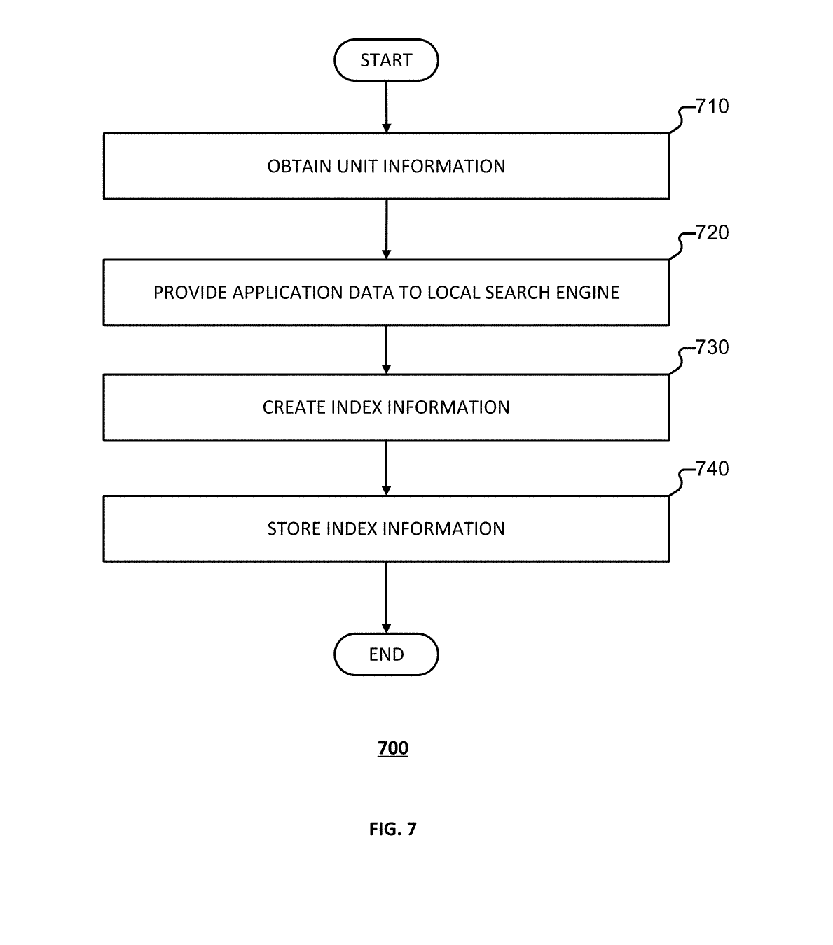

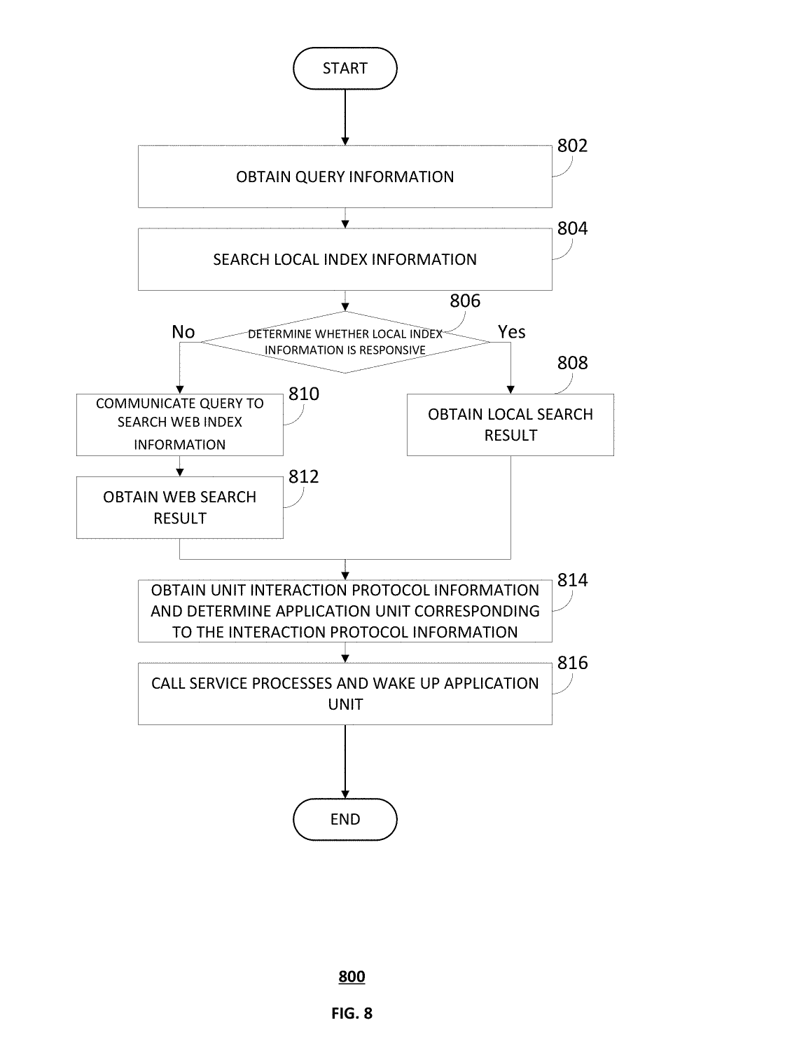

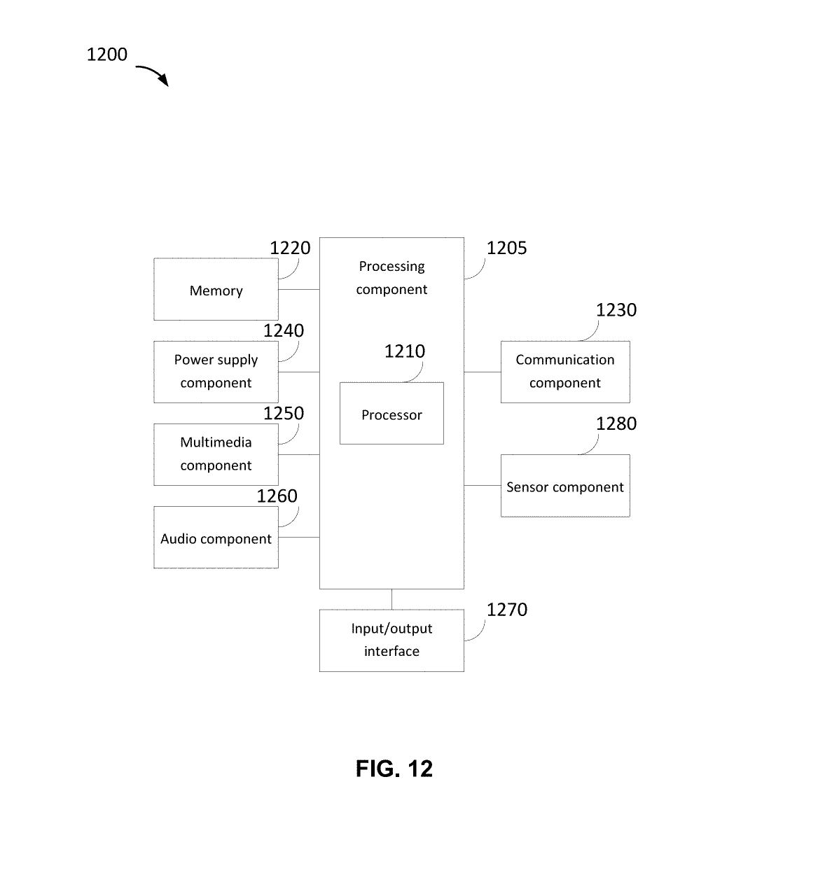

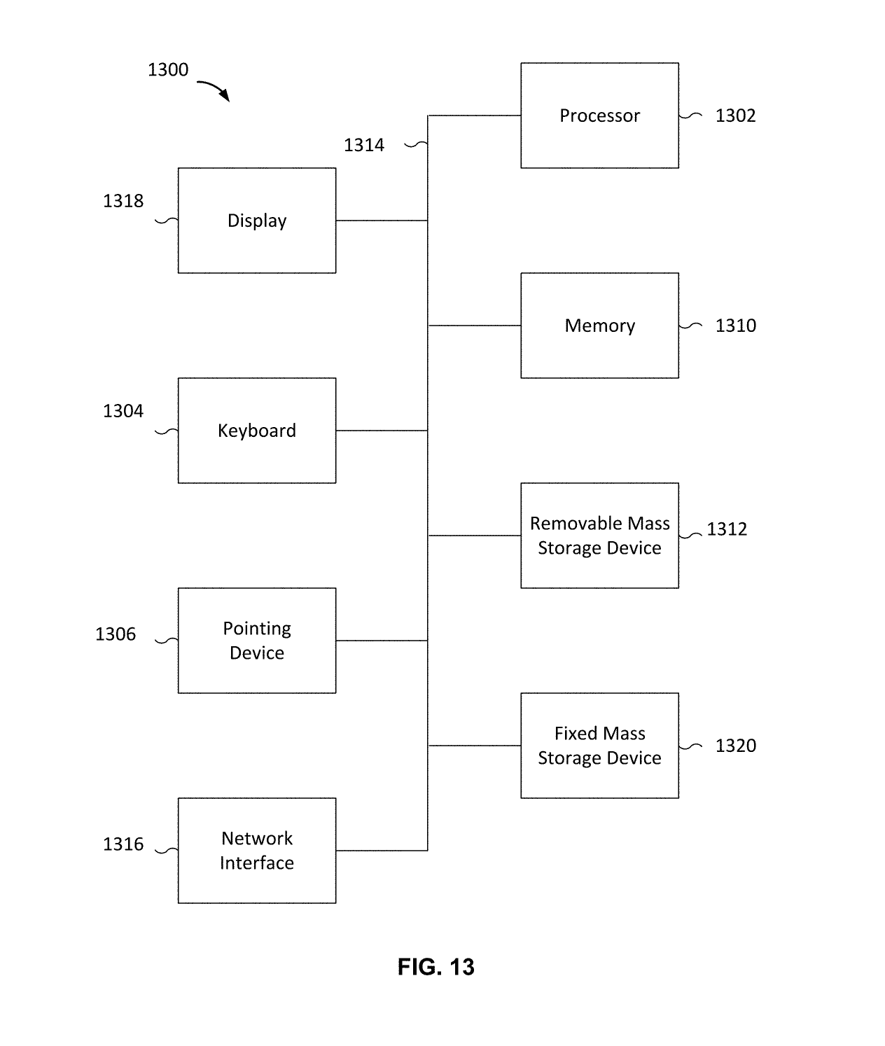

Referring to FIG. 1, main framework 100 of a context perceiving service is provided. Main framework 100 can be implemented, at least in part, by terminal 1200 of FIG. 12, and/or computer system 1300 of FIG. 13. Main framework 100 can be implemented in connection with process 500 of FIG. 5, process 600 of FIG. 6, process 700 of FIG. 7, and/or process 800 of FIG. 8.

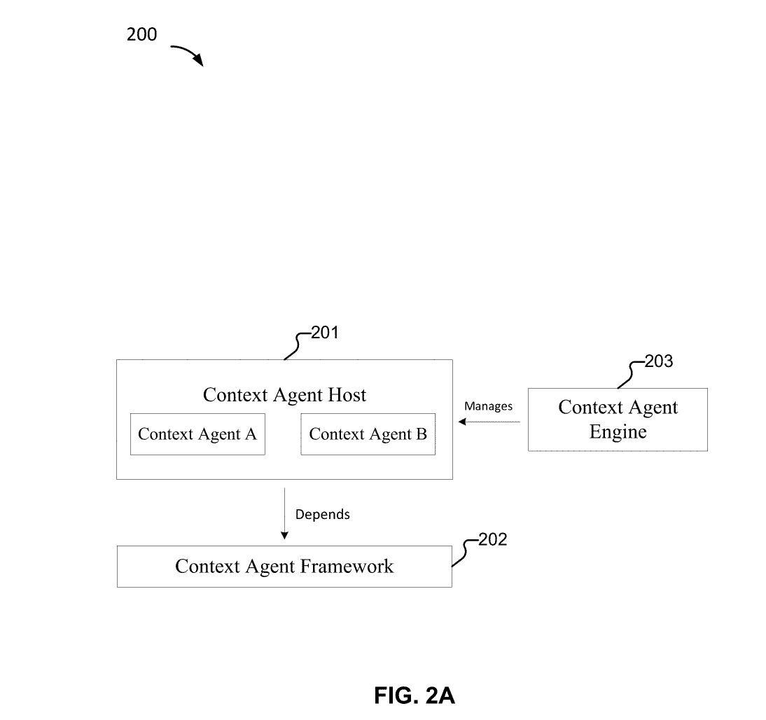

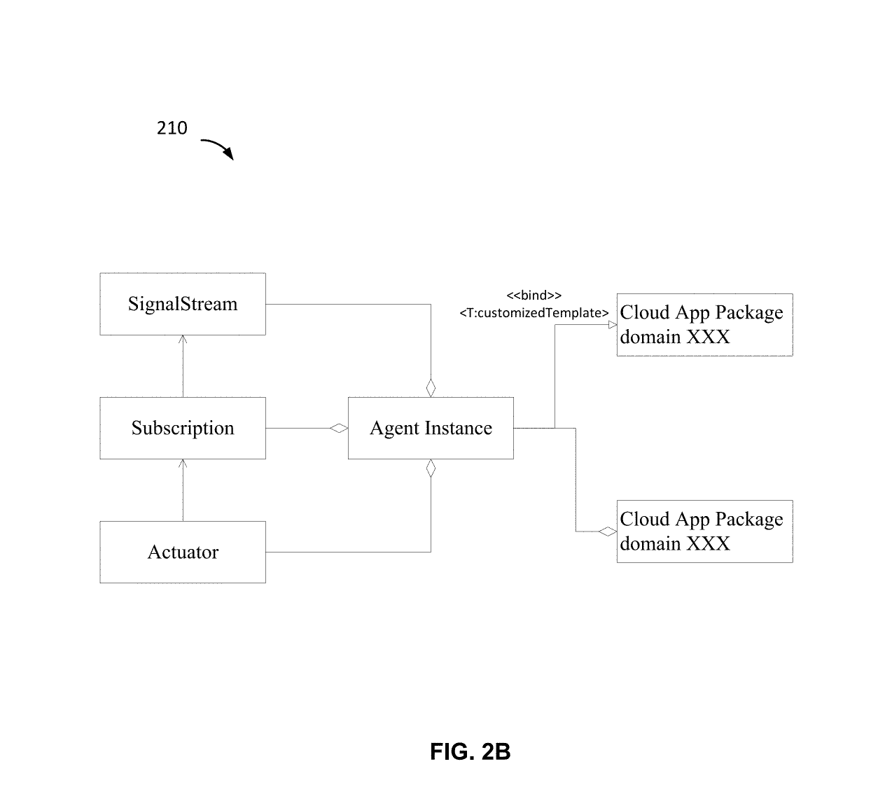

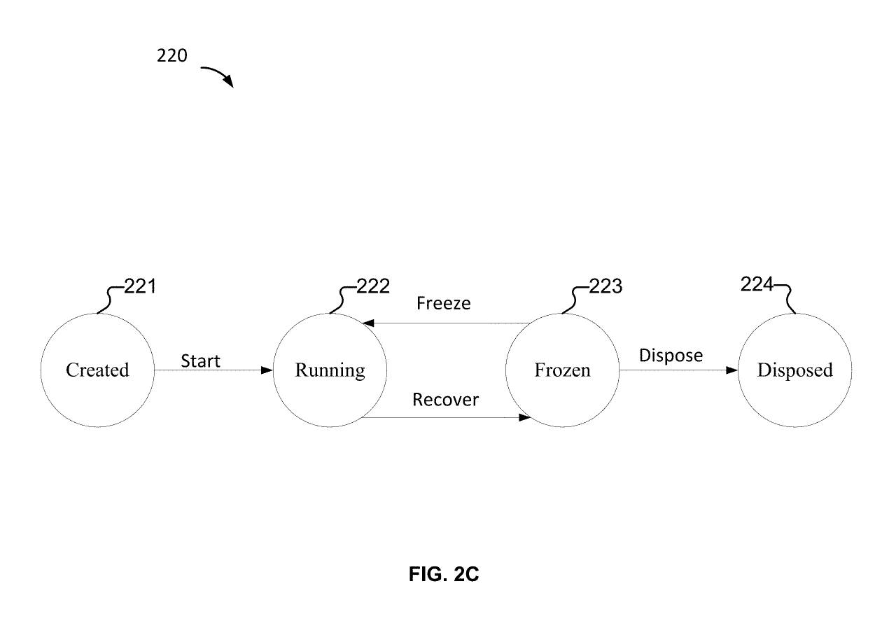

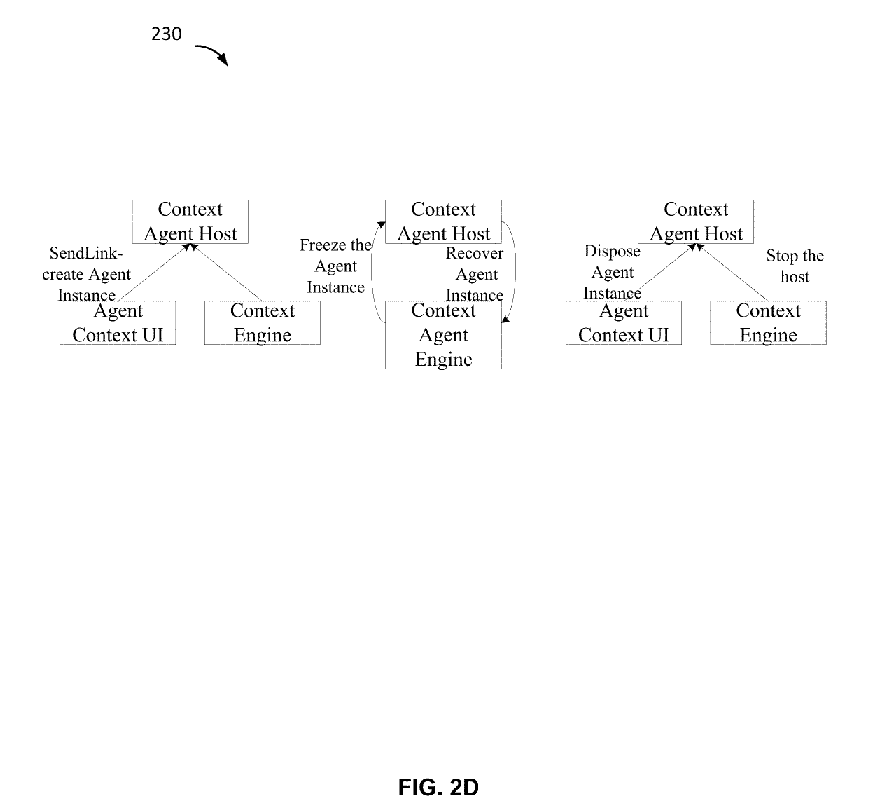

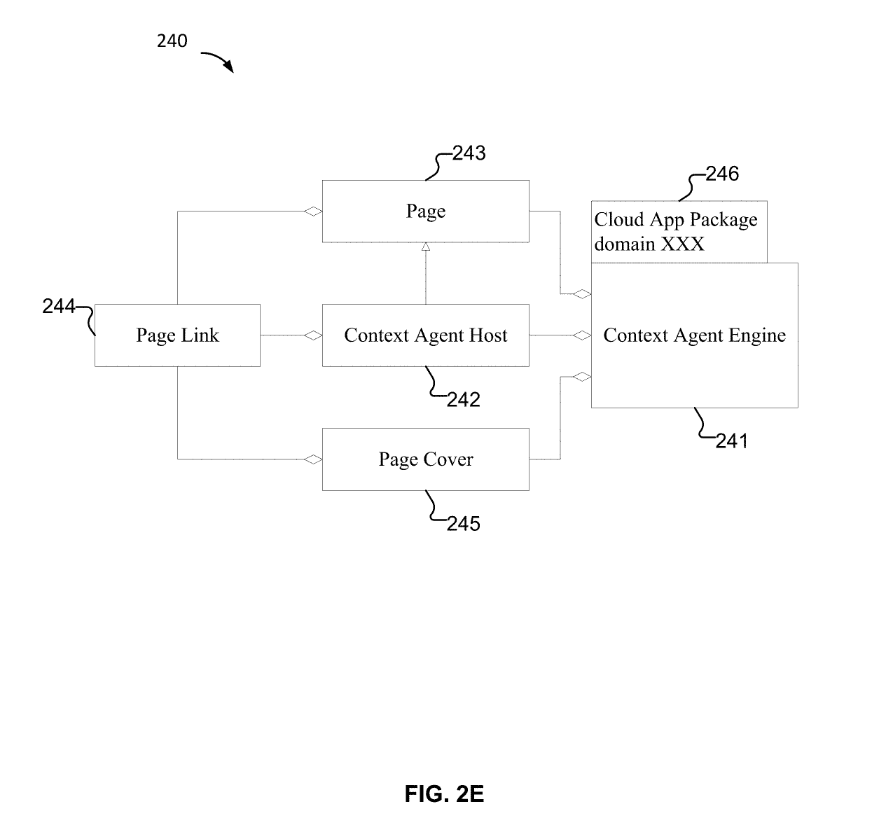

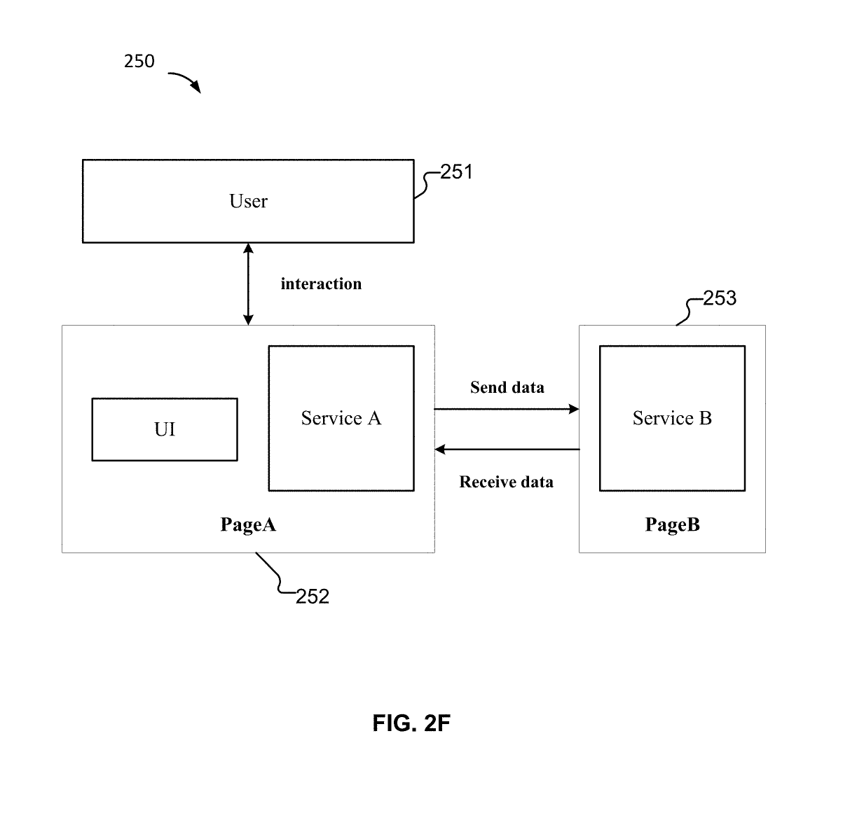

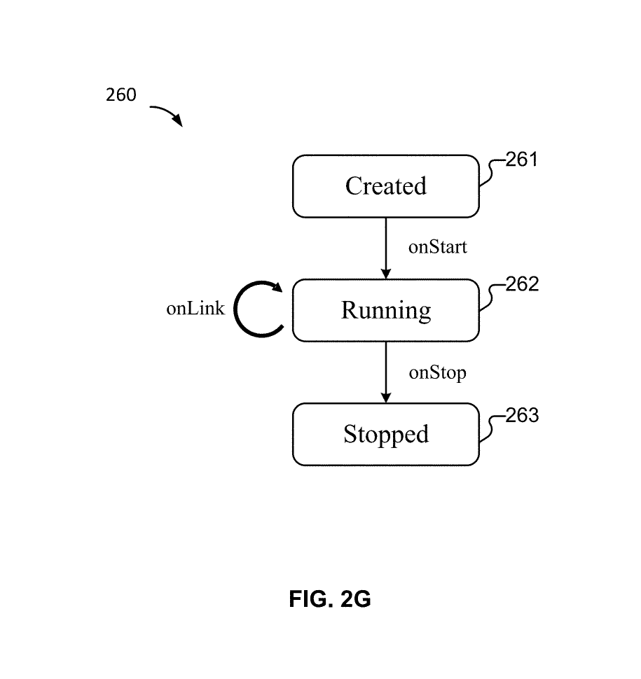

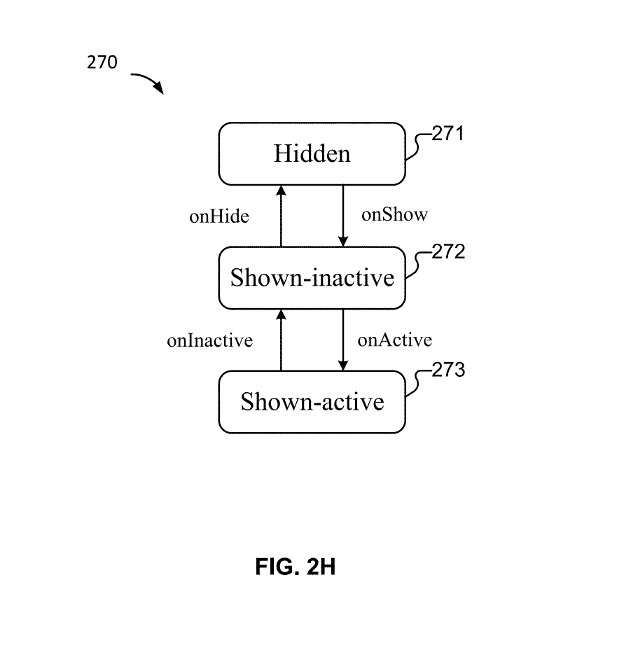

Main framework 100 includes three main modules: Context Agent Host 110, Context Agent Framework 120, and Context Agent Engine 130. An example of relationships among Context Agent Host 110, Context Agent Framework 120, and Context Agent Engine 130 is shown in FIG. 2A.

FIG. 2A is a diagram of relationships among modules within a main framework of a context-perceiving service according to various embodiments of the present application.

Referring to FIG. 2A, relationships of modules of main framework 200 is provided. Main framework 200 can be implemented in connection with a context perceiving service. Main framework 200 can implement main framework 100 of FIG. 1. Main framework 200 can be implemented, at least in part, by terminal 1200 of FIG. 12, and/or computer system 1300 of FIG. 13. Main framework 100 can be implemented in connection with process 500 of FIG. 5, process 600 of FIG. 6, process 700 of FIG. 7, and/or process 800 of FIG. 8.

As illustrated in FIG. 2A, main framework 200 includes Context Agent Host 201, Context Agent Framework 202, and Context Agent Engine 201. Context Agent Host 201 can correspond to Context Agent Host 110 of FIG. 1. Context Agent Framework 202 can correspond to Context Agent Framework 120 of FIG. 1. Context Agent Engine 203 can correspond to Context Agent Engine 130 of FIG. 1.

Context Agent Engine 203 manages a context application of the layer above. For example, Context Agent Engine 203 manages Context Agent Host 201 of the layer above the Context Agent Engine 203. Context Agent Host 201 relies on Context Agent Framework 202. A context agent can be implemented by Javascript code and the Context Agent Framework 202 can provide an API for the context agent.

Context Agent Host 201 can correspond to an application container having context perceiving capability. For example, Context Agent Host 201 can be configured to perceive contexts. For example, Context Agent Framework 202 can provide an API and a capability to receive a context signal (e.g., the Context Agent Host 201 can detect the context signal). According to various embodiments, Context Agent Host 201 inherits the most basic application unit (e.g., a Page, which can be the most basic unit of an application, etc.). Context Agent Framework 202 can provide an application unit that is inhered by Context Agent Host. A developer can use the Context Agent Host to organize an application context and to run the Context Agent Host on a system as an application. Context Agent Host 201 can be a start/stop agent.

Context Agent Framework 202 is a context engine application framework. A system base layer can use Context Agent Framework 202 to provide the higher-layer application (e.g., Context Agent Host 201) with context perceiving and context service capabilities. Context Agent Framework 202 can be a system framework (e.g., for the Context Agent Host 201). Context Agent Host 201 can receive a system signal (e.g., from Context Agent Framework 202) and calculate or otherwise determine the associated context based on the system signal (e.g., by comparing at least the system signal to one or more conditions associated with one or more contexts).

Context Agent Engine 203 is a context engine system service. Context Agent Engine 203 is an independent service built into a system and is responsible for managing the higher-layer application (e.g., Context Agent Host 201). Context Agent Engine 203 can be a system service to run an agent.

As illustrated in FIG. 1, Context Agent Host 110 (e.g., Context Agent Host 201) can include various context applications such as Context Agent A, Context Agent B, and/or Context Agent C.

As illustrated in FIG. 1, Context Agent Framework 120 (e.g., Context Agent Framework 202) can include: SignalStream, Subscription, Actuator, and/or Agent Instance. Each SignalStream, Subscription, Actuator, and/or Agent Instance can use a processing logic based on JavaScript. SignalStream, Subscription, Actuator, and Agent Instance are further described below.

An agent is a complete-context logical unit. The perceiving and logical processing of a context is described through an agent.

Agent Instance is an instance of an agent bound to an environment in a specific device (e.g., a terminal).

SignalStream corresponds to a signal stream. SignalStream is configured to collect (e.g., receive) and process signals (e.g., information) from various devices or systems. Higher-level applications are provided context perceiving capability through various operations relating to signals. The agent organizes logic associated context perceiving based on SignalStream. The agent can use the signal value of the SignalStream in connection with determining (e.g., calculating) a context or whether a context occurs.

Subscription corresponds to subscription relationships associated with various signals within a context. Connection to context perceiving and service is made via subscription. Connection to the context perceiving and service can be made in response to determining a context or determining that a context triggering event has occurred (e.g., satisfaction of one or more conditions associated with the context).

Actuator corresponds to a specific execution task that can be used within a context service. The Actuator can be processed based on the context perception and logical processing. For example, after perceiving that the weather is hot and humid, an Actuator controls air-conditioning activation.

As illustrated in FIG. 1, Context Agent Engine 130 (e.g., Context Agent Engine 203) can include: various modules for providing corresponding services, including Agent Management (context management), Execution Scheduling (task scheduling), Security Gatekeeper (security monitoring), Stream Management (signal stream), Subscription Management (subscription management), and/or Actuator Management (task management).

Context Agent Framework 120 provides the higher layer with context perceiving and service capabilities. For example, Context Agent Framework 120 can provide higher layers with functionality from SignalStream, Subscription, Actuator, Agent, and Agent Instance. The relationships among all of these component parts are as shown in FIG. 2B.

FIG. 2B is a structural diagram of a context application framework according to various embodiments of the present application.

Referring to FIG. 2B, context application framework 210 is provided. Context application framework 210 can be implemented in connection with a context perceiving service. Context application framework 210 can be implemented by main framework 100 of FIG. 1 and/or main framework 200 of FIG. 2A. Context application framework 210 can be implemented, at least in part, by terminal 1200 of FIG. 12 and/or computer system 1300 of FIG. 13. Context application framework 210 can be implemented in connection with process 500 of FIG. 5, process 600 of FIG. 6, process 700 of FIG. 7, and/or process 800 of FIG. 8.

As illustrated in FIG. 2B, context application framework 210 comprises Agent Instance that is connected with SignalStream, Subscription, and Actuator. Actuator can be further connected to Subscription, and Subscription can be further connected to Signal Stream. The Actuator can correspond to a signal for another agent (or another agent instance). Agent Instance can be further connected to one or more Cloud App Package domains. A Cloud App Package domain can correspond to an identifier for a corresponding Cloud App Package.

Context Agent Engine (e.g., context agent engine 230 of FIG. 2A) is configured to manage the applications (e.g., the context applications) and maintain the life cycles of the applications.

FIG. 2C is a life cycle diagram of a context application according to various embodiments of the present application.

Referring to FIG. 2C, context application life cycle 220 is provided. Context application life cycle 220 can be implemented in connection with a context perceiving service. Context application life cycle 220 can be implemented by main framework 100 of FIG. 1 and/or main framework 200 of FIG. 2A. Context application life cycle 220 can be implemented, at least in part, by terminal 1200 of FIG. 12 and/or computer system 1300 of FIG. 13. Context application life cycle 220 can be implemented in connection with process 500 of FIG. 5, process 600 of FIG. 6, process 700 of FIG. 7, and/or process 800 of FIG. 8.

At 221, an application is created. At created 221, the application is installed on the user target machine (e.g., the terminal). The application can be a context application.

At 222, the application is running. The application can have a status of running in connection with execution of the application by the terminal. An application having a status of running is operated according to logic organized by Agent (e.g., the agent in the context agent framework).

At 223, the application is frozen. The application is deemed to have a frozen status in the event that the application will not take up system resources, or in the event the application cannot run context services. The application can be re-awakened and run by Context Agent Engine.

At 224, the application is disposed. The application is deemed disposed in the event that the application has completed the corresponding context service or has stopped running the context service.

According to various embodiments, control of the application through context application life cycle 220 is controlled by Context Agent Engine such as Context Agent Engine 130. Context Agent Engine can control the application (e.g., the context application) to transition among statuses of created, running, frozen, and disposed.

FIG. 2D is a context agent engine management diagram according to various embodiments of the present application.

Referring to FIG. 2D, context agent engine management 230 is provided. The context agent engine of context agent engine management 230 can be implemented in connection with a context perceiving service. The context agent engine of context agent engine management 230 can be implemented by main framework 100 of FIG. 1 and/or main framework 200 of FIG. 2A. The context agent engine of context agent engine management 230 can be implemented, at least in part, by terminal 1200 of FIG. 12, and/or computer system 1300 of FIG. 13. The context agent engine of context agent engine management 230 can be implemented in connection with process 500 of FIG. 5, process 600 of FIG. 6, process 700 of FIG. 7, and/or process 800 of FIG. 8.

As illustrated in FIG. 2D, Context Agent Host is created based on Agent Context UI. Context Agent Host can be crated in response to a need or a determination that an agent instance is to be started/stopped. An agent instance can run in the Context Agent Engine. Context Agent Engine puts Context Agent Host in a frozen state (e.g., changes the status to frozen) and recovers the Running status of Context Agent Host. Context Agent Engine causes Context Agent Host to finish, and Dynamic Page Manager Service (DPMS) stops service. DPMS is a management service terminal for Page running instances. According to various embodiments, DPMS generally refers to a service process. An agent host can be a special Page that is managed by DPMS. Context Agent Engine can obtain Context Agent lifecycle information based on the DPMS.

After the Context Agent is developed, an automated context service can be provided based on the framework described above (e.g., the context agent framework). For example, after receiving a signal, Context Agent Framework could perceive the application context corresponding to the signal and determine the processing logic for that application context. The Context Agent Framework can call Context Agent Host to run the context application and perform processing (e.g., based on the perceived or determined application context corresponding to the signal). As an example, Context Agent Framework perceives through a mobile phone (e.g., using information obtained by one or more sensors or communication interfaces of the mobile terminal) that the air temperature is above 30° C. In response to perceiving (e.g., determining) that the air temperature is above 30° C., Context Agent Framework can cause the home air-conditioner to start up and run (e.g., to cool the home to a predefined threshold temperature). As another example, Context Agent Framework perceives through a security system signal that the home is locked and unoccupied. In response to perceiving (e.g., determining) that the home is locked and/or unoccupied, Context Agent Framework can cause the lamps to turn off and can cause other electrical appliances at home to turn off or otherwise transition to a sleep state to keep resources from being wasted. The Context Agent Framework can cause the lamps to turn off and can cause other electrical appliances at home to turn off or otherwise transition to a sleep state by invoking a command to be communicated to one or more corresponding terminals to process the command or associated function. The signals received or otherwise perceived by the Context Agent Framework can be various kinds of signal data received by the context perceiving system and include all kinds of signal data in the Internet of Things. For example, the signals can include information associated with one or more contexts associated with a terminal. Examples of the signals include various kinds of signals received by terminal devices such as sensor signals, signals corresponding to device instructions, signals from household security systems, and signals from lighting systems.

FIG. 2E is a structural diagram of a context application according to various embodiments of the present application.

Referring to FIG. 2E, context application 240 is provided. Context application 240 can be implemented in connection with a context perceiving service. Context application 240 can be implemented by main framework 100 of FIG. 1 and/or main framework 200 of FIG. 2A. Context application 240 can be implemented, at least in part, by terminal 1200 of FIG. 12 and/or computer system 1300 of FIG. 13. Context application 240 can be implemented in connection with process 500 of FIG. 5, process 600 of FIG. 6, process 700 of FIG. 7, and/or process 800 of FIG. 8.

According to various embodiments, various context applications can be developed (e.g., by developers) based on Context Agent Host 242. An application such as context application 240 can include Cloud Application Package 246, Context Agent Engine 241, Context Agent Host 242, Page 243, PageLink 244, Page Cover 245, or any combination thereof.

Context Agent Engine 241 can correspond to Context Agent Engine 203 of FIG. 2A.

Context Agent Host 242 can correspond to Context Agent Host 201 of FIG. 2A.

Cloud Application Package 246 is an application package for a context application. For example, Cloud Application Package is an entire application package for a context application. Cloud App Package 246 can be identified by domain. Cloud App Package 246 can include one or more pages (e.g., Page 243).

Page 243 can be the most basic unit of an application. For example, Context Agent Host 242 of context application 240 inherits Page 243. According to various embodiments, Page 243 represents an application unit that has contextualized perceiving and service capabilities. Page 243 can be a service component and could, for example, be an HTML5 web page. Page 243 can be similar to Android's Activity and iOS's ViewController. However, according to various embodiments, Page 243 differs from Android's Activity and iOS's ViewController because pages from different sources may be combined or nested in any way. Therefore, the use and display of Page 243 need not be constrained by a context application such as context application 240.

Page Cover 245 can be a viewing module within an application such as context application 240. Page Cover 245 can provide a human-machine interface for a user to interact with context application 240. For example, Page Cover 245 can provide the human-machine interface for the context service associated with context application 240.

PageLink 244 can correspond to an inter-application interaction protocol. For example, PageLink 244 can define a protocol by which various applications communicate (e.g., a protocol by which context application 240 communicates with other applications). PageLink 244 can be used in connection with waking a context application or to connect with other types of applications. According to various embodiments, PageLink 244 carries a data structure for inter-page interaction and communication.

On the basis of the main framework (e.g., main framework 100 of FIG. 1 or main framework 200 of FIG. 2A) described above, an example of a context-based application operation process executed by various devices and device interactions is as follows: Signal Stream in a device's Context Agent Framework collects and processes various device or system signals. The Signal Stream can collect the device or system signals via one or more sensors connected to the device or from a process running on the device that generates information indicative of a context of the device. Signal Stream then looks up subscription relationships (e.g., Subscription) of various signals and connects with context perception and services through Subscription. SignalStream can then determine a perception of a context and determine a logical processing (e.g., one or more commands) based on a logical unit (e.g., Agent). After context perception and logical processing are determined, the actual service task (Actuator) executes the specific device and environment-bound instance (Agent Instance). Signal Stream can cause the Actuator to perform execution of the Agent Instance (e.g., based on providing one or more signals to the Actuator). The Agent Instance can cause a higher-layer context application (e.g., Context Agent such as context application 240) to wake up. The higher-layer context application can be woken up based on the inter-application interaction protocol. PageLink 244 can be a protocol for interaction or communication between or among pages. In the Context Agent, the application unit (Page), which has contextualized perception and service capabilities, executes the operation for the application context. In the event that the user needs, or otherwise desires, to perform an interaction with the application unit, an application interface is displayed through a viewing module (Page Cover). According to various embodiments, Page Cover executes a human-machine interface for the context application. PageLink may connect with apps of other types so as to implement multi-device, multi-app interactive context operations. In the context perceiving and service providing process, a context engine (Context Agent Engine 241) is used to manage the ContextAgentHost, i.e., to manage the higher-layer context app and maintain the life cycle of the context app. The flow of the context app through various statuses can be managed and maintained in light of various signals.

According to various embodiments, after downloading a Cloud App Package 246 to a terminal (e.g., to the terminal device local system), and after the application context is perceived and responded to, the context application 240 is activated to provide a corresponding service. A human-machine interface can be provided (e.g., by Page Cover 245 of context application 240) to facilitate user control.

According to various embodiments, YunOS can run on a terminal, and YunOS-based Page management can be performed in connection with a context service.

(1) Page

As discussed above, a Page can be a service component (and can also be referred to as a service component). A Page can be an abstraction of local service and/or remote service. For example, a Page is a basic unit of an application service. A Page can provide various services. For example, a Page can provide various kinds of services by packaging data and methods. One service context can include a plurality of Pages (e.g., many different Pages). As an example, one Page can be a user interface (UI), a service for image capture, or other such service. As another example, a Page can be a background service, such as account authentication.

A running Page can be referred to as a Page instance. A Page instance can be a running carrier for a local service or a remote service. DPMS can create a Page instance (e.g., DPMS can create an instance of Page B after receiving a PageLink to Page B sent by Page A), schedule the Page instance, or manage the Page instance. DPMS can maintain the life cycle of a Page instance.

Each Page can be uniquely identified in the operating system running on the terminal (e.g., YunOS). For example, Page can be identified using a Uniform Resource Identifier (URI). URIs can be generated in various ways so long as uniqueness can be assured. The present application does not impose any limitations on how URIs are generated.

A URI can correspond to an address link. The URI can be used to uniquely determine its corresponding Page. For example, to help differentiate the service provided by a Page, it is possible to selectively include relevant information (e.g., title of service, summary of service, and service provider) associated with the service within the URI assigned to the Page.

For example, in connection with a calendar service provided by Company A, a URI assigned to the Page corresponding thereto could be as follows:

Page://calendar.a.com

In the above example, “Page://” is used to differentiate this address as the address corresponding to a Page and to differentiate it from addresses of other types; “calendar” indicates the title of the service provided; and “a” indicates the provider of the calendar service.

Multiple Page instances can be created in connection with a Page. For example, according to context requirements, one Page might require the creation of multiple Page instances. To help differentiate different Page instances corresponding to the same Page, a unique Page identifier (ID) can be assigned to each Page instance for the purpose of identification. The Page identifier can be assigned when the Page instance is created (e.g., contemporaneously with the creation of the Page instance). A Page instance is the Running status of a Page (e.g., the running carrier of a local or remote service). The Dynamic Page Manager Service (DPMS) creates, schedules, and manages a life cycle of the Page instance. The Page ID can be communicated in connection with communications referencing the Page instance. For example, the Page ID can be carried in an information entity (e.g., PageLink) and communicated to various modules in the context agent framework or the context application.

Events and/or data can be transmitted between Pages. A Page can interact with a user via a UI to provide service.

FIG. 2F is a diagram of inter-page relationships according to various embodiments of the present application.

Referring to FIG. 2F, an interaction with one or more pages 250 is provided. Interaction with one or more pages 250 can be implemented in connection with a context perceiving service. Interaction with one or more pages 250 can be implemented by main framework 100 of FIG. 1 and/or main framework 200 of FIG. 2A. Interaction with one or more pages 250 can be implemented, at least in part, by terminal 1200 of FIG. 12, and/or computer system 1300 of FIG. 13. Interaction with one or more pages 250 can be implemented in connection with process 500 of FIG. 5, process 600 of FIG. 6, process 700 of FIG. 7, and/or process 800 of FIG. 8.

A user can interact with one more pages in connection with a context service (e.g., being provided by a terminal used by the user). For example, a user can interact with (e.g., input to) Page A via a terminal. The user can submit an input to a touchscreen on the terminal, or receive information from the touchscreen on the terminal.

As illustrated in FIG. 2F, Page A 252 can send data such as an event (e.g., a system or user application event, or an indication of a system or user application event) to Page B 253, and/or obtain data from Page B 253. Page A 252 can interact with a user 251 via a UI. For example, Page A can cause a terminal to display the UI on a display (e.g., a touchscreen) of the terminal. Page A 252 can provide Service A (e.g., to the user), and/or Page B 253 can provide Service B (e.g., to the user). Page B 253 can provide Service B to the user via Page A 252. For example, Page A 252 can obtain data from Page 253 and provide such data to the user. Page A 252 can provide a display interface in the form of a UI to a user 251, present a service to the user 251 through the display interface, and receive various kinds of input from the user 251. Page B can run in the background and provide service support for other Pages such as Page A. For example, Page A 252 can interface with user 251 and Page B 253 can provide support or services to Page A 252 for interfacing with user 251. A Page can be created and destroyed during its life cycle. According to various embodiments, a Page passes through three statuses from creation to destruction.

FIG. 2G is a diagram of transitions of a page status according to various embodiments of the present application.

As an example of a transition of a page status, in response to a user launching an application or in response to receipt of a system signal, a corresponding Page can be created. As another example, in response to a user switching to a different application unit or a corresponding action or service is completed, the Page can be stopped.

Referring to FIG. 2G, life cycle 260 of a Page is provided. Life cycle 260 can be implemented in connection with a context perceiving service. Life cycle 260 can be implemented in connection with main framework 100 of FIG. 1 and/or main framework 200 of FIG. 2A. Life cycle 260 can be implemented, at least in part, by terminal 1200 of FIG. 12 and/or computer system 1300 of FIG. 13. Life cycle 260 can be implemented in connection with process 500 of FIG. 5, process 600 of FIG. 6, process 700 of FIG. 7, and/or process 800 of FIG. 8.

At 261, a Page is created. The Page can be created by DPMS. After the Page is created (e.g., instantiated), the Page initially enters into the Created status.

At 262, a Page is running. After a Page is activated, the Page enters into the Running status. When a Page has the Running status, events and/or data can be transmitted to and from the Page. For example, the Page can communicate information such as events and/or data to other pages (e.g., pages having the Running status). In the event that the Page is in the Running status, the Page can process events and/or data communicated by other Pages (e.g., other Pages in the Running status).

At 263, a Page is stopped. For example, after a Page is deactivated, the Page enters the Stopped status. A Page can be determined to be deactivated in response to a user switching to a different application unit, the terminal switching to a different application unit in response to one or more conditions being satisfied, the action or service associated with the Page being completed, etc. According to various embodiments, a Page that is in the Stopped status cannot communicate events and/or data with other Pages, or the Page in the Stopped status cannot process information communicated by (e.g., obtained from) other Pages.

According to various embodiments, a Page can switch (e.g., transition) between the different statuses (e.g., Created, Running, and Stopped) described above. A life event notification can be sent by DPMS and received at the time of switching. For example, the Page can obtain the life event notification. The life event notification can indicate to the Page the status of the Page after the Page switches statuses. According to various embodiments, DPMS can control Page status switching and life event notification.

As illustrated in FIG. 2G, when a Page transitions from the Created status to the Running status, the Page will receive an onStart event. When the Page transitions from the Running status to the Stopped status, the Page will receive an onStop event. When the Page is in the Running status, the Page can receive Pagelinks sent by other Pages via an onLink interface. According to various embodiments, the onStart event is the life event notification used in connection with instructing (e.g., to instruct) the Page to begin entering the Running status. According to various embodiments, the onStop event is the life event notification used in connection with instructing (e.g., to instruct) the Page to begin entering the Stopped status.

If the Page has a UI (user interface), then the Running status can be extended into one of the following three statuses: hidden, shown-inactive, and shown-active. The three statuses are further described below.

A hidden status corresponds to a status in which a page operates in the background in a manner that is invisible to the user. For example, a page with the hidden status can run in the background of the terminal and is invisible to the user during normal operation of the terminal.

A shown-inactive (e.g., visibly non-interactive) status corresponds to a status in which a page with such a status is visible to the user but is inactive with respect to interfacing or receiving interaction from a user. For example, a page with shown-inactive status is visible to the user, but does not respond to user input.

A shown-active (e.g., visibly interactive) status corresponds to a status in which a page with such a status is visible to the user and is active with respect to interfacing or receiving interaction from a user. For example, a page with shown-active status is visible to the user and can respond to user input.

As an example, Page A can be a full-screen window; Page B can be a non-full-screen window. In the event that Page B is displayed on Page A, Page A has shown-inactive status, and Page B has shown-active status.

FIG. 2H is a diagram of transitions of a page status according to various embodiments of the present application.

Referring to FIG. 2H, life cycle 270 of a Page is provided. Life cycle 270 can be implemented in connection with a context perceiving service. Life cycle 270 can be implemented in connection with main framework 100 of FIG. 1 and/or main framework 200 of FIG. 2A. Life cycle 270 can be implemented, at least in part, by terminal 1200 of FIG. 12 and/or computer system 1300 of FIG. 13. Life cycle 270 can be implemented in connection with process 500 of FIG. 5, process 600 of FIG. 6, process 700 of FIG. 7, and/or process 800 of FIG. 8.

During life cycle 270 of a Page, the Page can switch between different statuses. For example, the Page can transition among hidden status 271, shown-inactive status 272, and/or shown-active status 273. Certain pages can transition between any combination of hidden status 271, shown-inactive status 272, and/or shown-active status 273. For example, certain Pages may only transition between two of the hidden status 271, shown-inactive status 272, and/or shown-active status 273.

A Page can transition between status based on (e.g., in response to) life event notifications. For example, in response to a use selecting an application or providing an indication that the user or terminal wants to use a server supply by an application unit, an onShow event is generated. As an example, in response to receiving an indication that the terminal or user does not want to use the application for an amount of time or wants to close the application unit, or switch to another application unit, etc., an onInactive event is generated. As illustrated in FIG. 2H, after (e.g., in response to) a Page in hidden status 271 receives an onShow event, the Page transitions to shown-inactive status 272; after (e.g., in response to) a Page in shown-inactive status 272 receives an onHide event, the Page transitions to hidden status 271; after (e.g., in response to) a Page in shown-inactive status 272 receives an onActive event, the Page transitions to shown-active status 273; and/or after (e.g., in response to) a Page in shown-active status 273 receives an onInactive event, the Page transitions to shown-inactive status 272.

(2) PageLink

PageLink is an information entity for flows (e.g., an object configured to facilitate communication of information) between Pages. PageLink can transmit information, such as events and/or data, between Pages. A predefined Application Programming Interface (API) can be used for communication between pages. For example, the API can be used for specific transmission of data. As an example, YunOS uses PageLink as a basis for recording relationships between service components. PageLink can designate the URI of the target Page and can include one or more types of information, including events, data, and services.

As an example of information (e.g., events and/or data) communicated between Pages, if the second Page-oriented PageLink includes data and an event, then the second Page according to the data included in the PageLink, executing an operation corresponding to the event included in the PageLink. For example, if the event transmitted to the second Page via the PageLink is an event in which a user clicks a “payment” button on a web page to execute payment, then the data transmitted to the second Page via the PageLink includes user account, payment amount, and recipient, and the following operations can be executed when the second Page processes the PageLink: logging into the payment page with the user account and performing on-line payment operation of the amount to the recipient when the user clicks the “payment” button on the web page.

Various embodiments combine (e.g., integrate) Pages through PageLink in a manner that is more flexible than conventional art and thus various embodiments can implement a wide array of service contexts.

(3) DPMS

DPMS is the English abbreviation for Dynamic Page Manager Service. In Chinese, it is called Dynamic Page Management Service. DPMS can correspond to a service component management entity. For example, DPMS is a form of system service. DPMS can manage Page life cycles and runtime scheduling. For example, DPMS can manage the Page life cycle from creation to destruction. DPMS can implement inter-Page interactions via PageLink. For example, all inter-Page interactions via PageLink can be implemented by DPMS.

Various embodiments provide a service component management system. The service component management system can comprise a service component management entity and N (N being an integer greater than 1) service components. The service component management entity can receive an information entity (e.g., PageLink) sent by one service component Page (referred to herein as a first service component for convenience of description) directed at another service component Page (referred to herein as a second service component for convenience of description) and send the PageLink to the second service component for processing.

Various embodiments provide a system-layer search method and can, on the basis of a search Page, provide users with needed services and implement seamless searches.

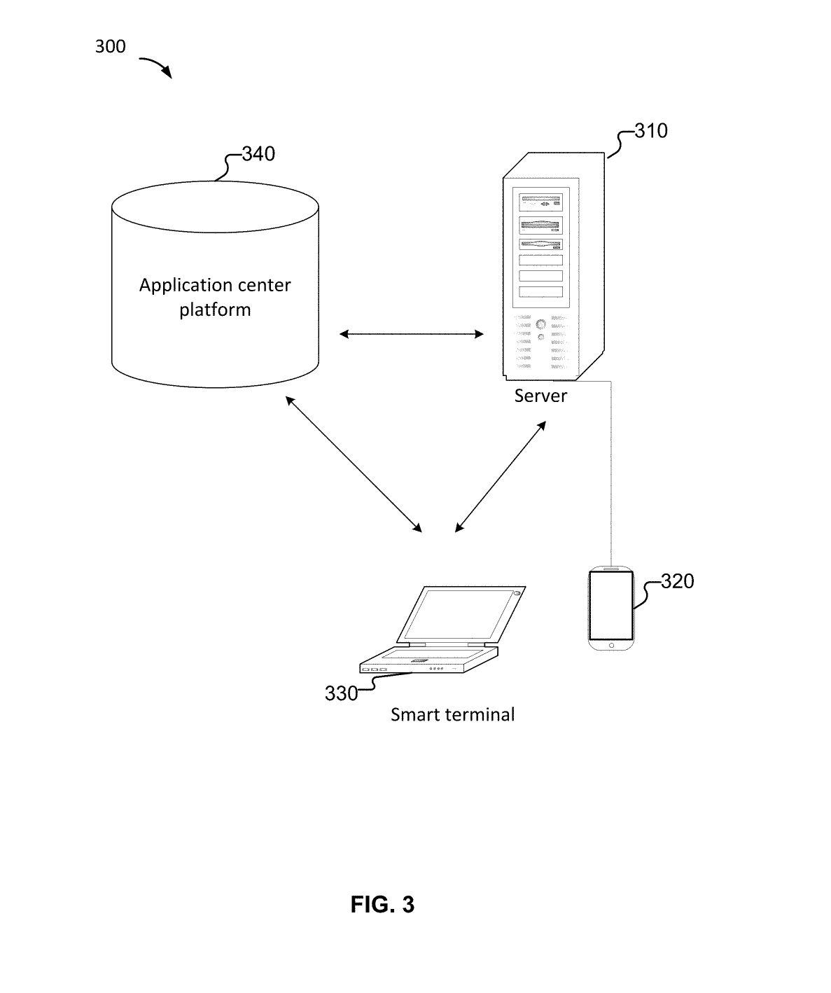

FIG. 3 is a processing diagram of a search system according to various embodiments of the present application.

Referring to FIG. 3, system 300 is provided. System 300 can implement main framework 100 of FIG. 1, main framework 200 of FIG. 2A, process 500 of FIG. 5, process 600 of FIG. 6, process 700 of FIG. 7, process 800 of FIG. 8, terminal 1200 of FIG. 12 and/or computer system 1300 of FIG. 13.

System 300 can include server 310, terminal 320 (e.g., a smartphone or other mobile terminal), terminal 330 (e.g., a laptop or other smart terminal), application center platform 340 (e.g., Google PlayStore®, Apple App Store®, etc.).

According to various embodiments, system 300 is a search system based on a context-perceiving system.

Application center platform 340 (e.g., Page Center) is a platform for an application center used to manage Pages. App center platform 340 can receive applications or application units (Pages) uploaded by developers. App center 340 can be hosted in the Cloud (e.g., by one or more remote servers by which a terminal can connect via a network such as the Internet).

Server 310 is a platform that provides searches. For example, sever 310 comprises a web search engine (e.g., Cloud Search Engine). Application center platform 340 (e.g., Page Center) can, serving as a server data source, provide search data for server 310. Server 310 can receive information for one or more queries from terminal 320 and/or terminal 330. Terminal 320 and/or terminal 330 can be a user-operated device. Terminal 320 and/or terminal 330 can be configured to comprise local search engines. For example, the local search engine of terminal 320 and/or terminal 330 can search data from server 310. The local search engine can submit a query to server 310. The local search engine can determine search data and acquire search results from the server. For example, the local search engine can, based on applications in the terminal device, determine search data and acquire search results from the server.

An application unit (e.g., a Page) can undergo any combination or nesting without constraint from an application. By running combinations of application units, the application units can build results similar to those from running an application. For example, the application that is visible to (e.g., seen by) the user is built from multiple, split application units. As an example, a home page in a shopping application can display multiple items, such as Group Purchasing, Supermarket, Mall, Take-Out, Travel, and Ticket Purchasing. Each one of these items could be carried by an application unit (e.g., a specific application unit can provide the functionality for one or more of the multiple items displayed by the home page in the shopping application). The user can be provided with all service functions associated with multiple application units that are combined. Therefore, a user can directly search for an application unit in a device and can run that application unit (e.g., run an instance of the service component). Thus, without having to install an app, it is possible to provide the user with an application unit service and thus increase the speed and convenience of searching, user operation, and service.

Server 310 can acquire application data from application center platform 340 and create web index information. According to various embodiments, terminal 320 and/or terminal 330 creates local index information based on application data corresponding to local applications (e.g., applications respectively installed thereon). Index information can comprise a URL of a page (e.g., application unit), content supplied by Page (e.g., title, article, news), a unique identifier (ID) of content, address of thumbnail, etc. Index information can include specific services of the applications or information associated with the specific services of the applications. Index information can comprise metadata or descriptive information associated with the applications. Various index data structures such as suffix tree, inverted index, citation index, Ngram index, document-term matrix, etc. can be employed and the corresponding index generated based on the application data (e.g., title, summary, or other descriptions of the application), using third party libraries. In the event that a search is performed at terminal 320 and/or terminal 330, it is possible to conduct application-related information queries based on local index information (e.g., index information stored locally and accessible locally at the corresponding terminal) and/or web index information (e.g., index information stored remotely and accessible via server 310).

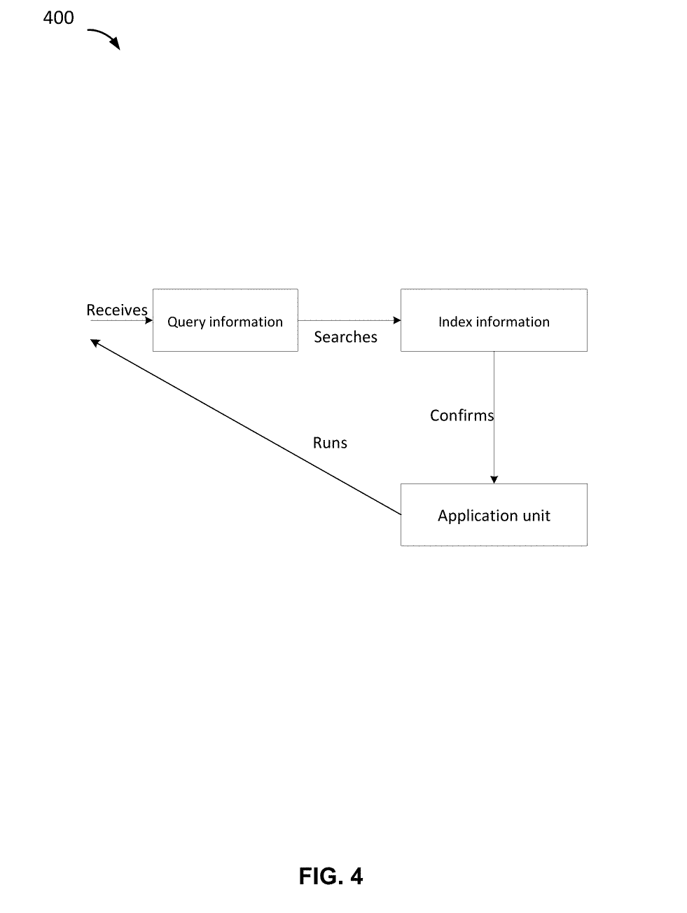

FIG. 4 is a search diagram according to various embodiments of the present application.

Referring to FIG. 4, search 400 is provided. Search 400 can be implemented, at least in part, by main framework 100 of FIG. 1, main framework 200 of FIG. 2A, process 500 of FIG. 5, process 600 of FIG. 6, process 700 of FIG. 7, process 800 of FIG. 8, terminal 1200 of FIG. 12, and/or computer system 1300 of FIG. 13.

As illustrated in FIG. 4, search 400 includes receiving query information, searching index information, identifying an application unit, and/or running the identified application unit.

The query information can be submitted by a user via a user interface on a terminal. The user can input the query information, or select a command associated with a predefined query.

In response to receiving the query information, a query can be run against local index information and/or web index information. The query can be run against both the local index information and the web index information, and the results from the respective queries can be merged. The query can be run against a local index information first, and if a result is not obtained by querying the local index information, the query can be performed run against the web index information. The terminal can determine to select one or both of the local index information and the web index information to query for the query information. The terminal can query the local index information and the web index information in parallel or in series (e.g., the terminal can first determine whether the local index information comprises information responsive to the query associated with the query information and thereafter query the web index information in the event that information responsive to the query is not found in the local index information).

The terminal can identify information responsive to the query associated with the query information. For example, the information responsive to the query can comprise one or more application units. In the event that information responsive to the query is located, the terminal can run one or more of the application units that are responsive to the search.

FIG. 5 is a flowchart of a method for operation of a context-based application according to various embodiments of the present application.

Referring to FIG. 5, process 500 for operation of a context-based application is provided. Process 500 can be implemented, at least in part, by main framework 100 of FIG. 1 and/or main framework 200 of FIG. 2A. Process 500 can be implemented in connection with process 600 of FIG. 6, process 700 of FIG. 7, and/or process 800 of FIG. 8. Process 500 can be implemented by a system for performing search 400 of FIG. 4, terminal 1200 of FIG. 12, and/or computer system 1300 of FIG. 13.

At 510, a query is obtained. The query can be obtained by a terminal (e.g., a terminal that is used by a user). The query can comprise query information. For example, the query information can correspond to a search to be performed. The query (e.g., the query information) can be received from a user via a user interface on a terminal. As an example, the user can submit the query information to a search field on a user interface. The user can input the query (e.g., the query information), or select a command associated with a predefined query (e.g., associated with predefined query information). The query information can comprise one or more characters. The characters may include any type of character, such as symbols, letters, numbers, and Chinese characters.

At 520, index information is searched. The index information can be searched based on the obtained query. For example, the index information can be searched using the query information.

In response to receiving the query information, a query can be run against local index information and/or web index information. The query can be run against both the local index information and the web index information, and the results from the respective queries can be merged. The query can be run against a local index information first, and if a result is not obtained by querying the local index information, the query can be performed run against the web index information. The terminal can determine to select one or both of the local index information and the web index information to query for the query information. The terminal can query the local index information and the web index information in parallel or in series (e.g., the terminal can first determine whether the local index information comprises information responsive to the query associated with the query information and thereafter query the web index information in the event that information responsive to the query is not found in the local index information).

The local index information can be stored locally at the terminal that obtained the query. The web index information can be stored remotely at a server with which the terminal that obtained the query can communicate via a network.

At 530, an application unit is determined. The application unit can be determined based on a result of a search of the index information. For example, the application unit can be identified as being responsive to the search of index information in connection with the query.

At 540, the application unit is run. In some embodiments, the application unit is automatically run in response to the application unit being responsive to the obtained query. In some embodiments, the application unit is provided (e.g., displayed) to the user as being responsive to the query, and the application unit is run in response to a user selecting the application unit in connection with the application unit being provided as being responsive to the query.

According to various embodiments, if a user, while using a smart device, wishes to use a certain service function or wishes to use some functions of an application, the user can directly activate a system search. For example, the user can run a first Page (e.g., referred to in this example as a first application unit) providing a search service, and the user can input query information in the UI of the first Page. The terminal device can, based on the first Page (and the interaction by the user therewith), receive user query information and communicate the query information via PageLink. The query information can comprise one or more characters. The characters may include any type of character, such as symbols, letters, numbers, and Chinese characters. In some embodiments, in the event that the query information is obtained, the query information can further undergo various kinds of pretreatment. As an example, keywords can be obtained (e.g., identified or otherwise extracted) from the query information. As another example, Chinese and letters may be subject to word segmentation processing to obtain the query information's key words for searching.

During the search, the query information may be used to search index information. For example, index information is looked up based on the query information (e.g., with key words associated with the query information) to obtain the corresponding application data as the search result. A Page may be determined (e.g., by the terminal or a user thereof) based on the search result. The Page that is found (e.g., determined to be responsive to the query) can be called a second application unit or the second Page. The search information therein (e.g., in the search index) is based on application data. After the second Page is determined, the second Page may be run (e.g., on the terminal). For example, an instance of the service component is run, thus providing looked-up service functions to the user. Application units can be combined or nested to provide various service functions. Thus, in the case of application units acquired from the network, it is possible, without installing applications, to directly execute functions to provide users with services.

According to various embodiments, after a user inputs query information, system signals for searching may be correspondingly received. Thus, a local search engine conducts a search based on Subscription relationships. After an application unit (Page) is found, DPMS may be woken with a PageLink to run a Page instance. DPMS can be woken up by the search service. For example, the local search engine can have a search service that can wake up the DPMS.

In some embodiments, after query information is received, query information may be used to search index information. An application unit is determined according to a result of the search of the index information. Application units include units obtained by splitting an application. Then the application unit may be run, and the user is provided with a needed functional service through the application unit, thereby achieving seamless search and support for the service function and increasing search convenience and rapidity.

According to various embodiments, a search in connection with the query can include a search based on local index information and/or can include a search based on web index information. Index information can be created locally and separately in a network to support system searches in the device. The index information can include all application content for applications (e.g., Weibo, a message, contact, album, etc.)

FIG. 6 is a flowchart of a method for building a search index according to various embodiments of the present application.

Referring to FIG. 6, process 600 for building a search index is provided. Process 600 can be implemented, at least in part, in connection with main framework 100 of FIG. 1 and/or main framework 200 of FIG. 2A. Process 600 can be implemented in connection with process 500 of FIG. 5, process 700 of FIG. 7, and/or process 800 of FIG. 8. Process 600 can be implemented by a system for performing search 400 of FIG. 4, terminal 1200 of FIG. 12, and/or computer system 1300 of FIG. 13. Process 600 can be performed by a server.

At 610, application data is obtained. A server can obtain the application data from an application center platform (e.g., Google PlayStore®, Apple App Store®, etc.). The application data can include information associated with one or more applications. For example, the application data can include information associated with one or more applications available for download at the application center platform.

At 620, index information is created. The index information can be created based on the application data (e.g., obtained from the application center platform). The index information can include a unique identifier, title, content, a thumbnail, metadata or other data, etc. The search index can add information to the index information. The index information can correspond to web index information. In some embodiments, the server creates web index information based on the application data. For example, the server can crawl web information and build an index associated with the obtained information. The server can provide the web index information, or access to the web index information, to one or more terminals in communication with the server.

At 630, the index information is stored. A server can store the index information. The index information can correspond to the web index information described herein. In some embodiments, the index information can be stored remotely on a repository. For example, the repository can be remote relative to a terminal. The index information can be stored in a manner that is accessible to the server in order to allow the server to provide a web service to one or more terminals. For example, the index information is stored in a manner such that queries obtained from one or more terminals via a network can be performed against the index information. The web index information can be a part of a web index.

According to some embodiments, the server is configured with a web search engine (e.g., the Cloud Search Engine). For example, the web search engine is set up within a server. The Cloud Search Engine can be used to obtain application data from an application center platform. In some embodiments, a crawler is used to collect application data from the application center platform (e.g., the Page Center).

The Page Center receives developed application units and application data associated with application units. The Page Center can also receive other application-related information. According to various embodiments, application data includes unit information of application data. The unit information can be information used in describing and/or searching for application units. The unit information can comprise at least one of the following: application descriptive information, application address information, and unit interaction protocol information. The application descriptive information can include information used in connection with describing application units, including describing application unit functions (e.g., functionality of the corresponding application unit), developers, versions, and other such information. The application address information can include information for representing the address at which the application unit is stored (e.g., on the Web or other network), the address at which the application unit is stored locally, the call address associated with the application unit, and other such information. The unit interaction protocol information can include the information entity (e.g., PageLink) for the Page.

After the application data is obtained, the web index information can be created. For example, the Cloud Search Engine can be used to create web index information. The web index information can be used in connection with providing search information relating to the application units. In the event that a terminal device of the network conducts a search (e.g., submits to the server a query), application units can be searched based on the web index information. For example, the server can perform a query against the web index information to identify application units that are responsive to the query.

In some embodiments, the terminal is configured with a local search engine (e.g., Local Index Engine). The local search engine can process queries against index information such as local index information. For example, the application data of local applications can be provided to the local search engine (e.g., Local Index Engine). The local search engine (e.g., Local Index Engine) can create local index information based on the application data (e.g., associated with applications locally installed at the terminal). The terminal can obtain a query based on query information submitted by a user and the terminal can perform a search against the local index information based on the query to obtain a search result.

FIG. 7 is a flowchart of a method for building a search index in a terminal according to various embodiments of the present application.

Referring to FIG. 7, process 700 for building a search index is provided. Process 700 can be implemented, at least in part, in connection with main framework 100 of FIG. 1 and/or main framework 200 of FIG. 2A. Process 700 can be implemented in connection with process 500 of FIG. 5, process 600 of FIG. 6, and/or process 800 of FIG. 8. Process 700 can be implemented by a system for performing search 400 of FIG. 4, terminal 1200 of FIG. 12, and/or computer system 1300 of FIG. 13. Process 700 can be performed by a client terminal.

At 710, unit information is obtained. The unit information can be obtained by the terminal. As an example, the unit information can correspond to information associated with an application unit in an application. For example, when the application is running, the unit information corresponds to an application unit in the application. The unit information can comprise information of the application unit such as, a Uniform Resource Identifier (URI). The unit information can be obtained when the application is running.

At 720, application data is provided to the local search engine. The application data can be obtained by extracting key information, or certain or identified information from the unit information. The obtaining of the application data can include converting the application data to a predefined format, etc. In some embodiments, the application data is obtained based on the unit information. The application data can be created based on the unit information. In some embodiments, the unit information that is obtained in connection with an application is deemed to be the application data.

At 730, index information is created. Existing indexing techniques such as suffix tree indexing, inverted indexing, citation indexing, Ngram indexing, document-term matrix indexing, etc., can be used to create the index information. The index information can be created based on the application data (e.g., obtained from the unit information). The index information can correspond to local index information. In some embodiments, the terminal creates local index information based on the application data. The terminal can process a query against the local index information. The index information can be created by tokenization, building an index, and storing the index information. The index information can include a title, content, a URI, a picture, metadata, etc.

At 740, the index information is stored. The terminal can store the index information. The index information can correspond to the local index information described herein. In some embodiments, the index information can be stored locally at the terminal (e.g., on a storage medium of the local terminal). The index information can be stored in a manner that is accessible to the terminal in order to allow the terminal to process a query against the index information. The local index information can be a part of a local index.

The application unit in the terminal can be run to provide a service (e.g., to the user). For example, the application unit can be run based on a request from the user or otherwise in connection with the providing of a service to the user. In some embodiments, the unit information corresponding to the service-providing application unit is obtained. The obtained unit information can be regarded as application data and can be sent to the local search engine (e.g., the Local Index Engine). The obtaining of the unit information corresponding to an application unit in the application can comprise: obtaining the unit information corresponding to the application unit when the application opens the user interface corresponding to the application unit. For example, the unit information corresponding to the application unit can be obtained in connection with the invocation of the user interface (e.g., to be displayed to the user) associated with the application unit. In the event that the application executes the application unit to provide the user with a service, the application can display a corresponding user interface. In the event that a user desires to obtain a certain functional service, the user can invoke a corresponding application or application unit (e.g., the user can select the corresponding app unit). The application unit opens the user interface corresponding to the application unit, thus making it possible to acquire unit information corresponding to the app unit. In an embodiment of the present application, application data includes: unit information of application data. The unit information can include information used in connection with describing and searching for application units. The unit information can include at least one item of application descriptive information, application address information, and unit interaction protocol information. The app descriptive information is for describing application units, including describing application unit functions (e.g., functionality of the corresponding application unit), developers, versions, and other such information. The application address information is for representing the address where the application unit is stored (e.g., on the Web or other network), the address at which the application unit is stored locally, the call address associated with the application unit, and other such information. The unit interaction protocol information can be the information entity (e.g., PageLink) for the Page.

Local index information can be created based on the application data. For example, after the application data is obtained, the Local Index Engine can be used to create local index information. The local index information can include information associated with providing search information relating to one or more application units. In connection with a local search (e.g., when a terminal conducts a search locally), application units in the terminal can be searched on the basis of the local index information.

According to various embodiments, index information for information searches can be created both locally and on the Web. Various embodiments can be implemented in connection with an Internet of Things system. Internet of Things devices within the Internet of Things system can interact through search application units (e.g., Pages). When each Internet of Things device (e.g., a terminal) locally makes use of application data to create local index information, the Internet of Things device can upload the application data to a web search engine. The web search engine can use the application data uploaded by the Internet of Things devices and application data obtained from an application center platform (e.g., application data collected by an application center platform crawler) to jointly create web index information. According to various embodiments, each Internet of Things device is connected based on a server to achieve true interconnection of Internet of Things devices and seamless searching. An Internet of Things device can, on the basis of a search, acquire the applications units (Pages) of other Internet of Things devices and achieve inter-device interaction and control through app units (Pages).

After index information is created locally and on the Web, searches can be conducted based on the local search engine and/or the web search engine.

FIG. 8 is a flowchart of a method for performing a search according to various embodiments of the present application.

Referring to FIG. 8, process 800 for performing a search is provided. Process 800 can be implemented, at least in part, in connection with main framework 100 of FIG. 1 and/or main framework 200 of FIG. 2A. Process 800 can be implemented in connection with process 500 of FIG. 5, process 600 of FIG. 6, and/or process 700 of FIG. 7. Process 800 can be implemented by a system for performing search 400 of FIG. 4, terminal 1200 of FIG. 12, and/or computer system 1300 of FIG. 13. Process 800 can be performed by a client terminal or a server.

At 802, query information is obtained. A terminal can obtain the query information from the user. For example, the query information can be submitted by a user via a user interface on a terminal. The user can input the query information, or select a command associated with a predefined query.

At 804, local index information is searched. The local index information can be searched based on the query information. In response to receiving the query information, the terminal can run a query against the local index information based on the query information.

If, while using a terminal such as a smart device (e.g., a smart phone), a user wishes to use a certain service function or wishes to use some functions of an application, the user can directly activate a system search. For example, the user can cause the terminal to run a first Page (referred to as a first application unit) that provides search service. The user can input query information in the UI of the first Page in connection with the search service. Thus, the terminal can, based on the first Page, receive user query information and communicate the query information via PageLink. The query information can include one or more characters. The characters can include any type of character, such as symbols, letters, numbers, and Chinese characters. In some embodiments, the query information can include a sound, an image, a biometric characteristic associated with the user (e.g., a finger print, an iris, an image of the user's face, etc.) etc. After receiving the query information, the query information can further undergo various processing. For example, one or more keywords associated with the query information can be extracted from the query information, or otherwise obtained based on the query information. For example, Chinese and letters can be subject to word segmentation processing to obtain the key words associated with the query information for searching

A local search engine can be called to search for the query information (or information responsive to the query information). For example, the local search engine can be invoked in connection with the query associated with the query information. The local search engine can process the query against the local index information (e.g., search for the query information in the local index information). Based on a result of the processing of the query (e.g., a search result), the local search engine can determine whether an application unit matching the query information can be looked up. For example, the local search engine can determine whether the local index information comprises information that is responsive to (e.g., matching) the query information. The search result can comprise application data and other information (e.g., application unit information such as PageLink, URI, etc.).

At 806, it is determined whether the local index information is responsive to the query. For example, it is determined whether the local index information comprises information (e.g., application data) that is responsive to (e.g., matching) the query information. The local search engine can determine whether the local index information is responsive to the query. For example, the local search engine can determine whether the query run against the local index information returned any search results.

In the event that it is determined that the local index information is responsive to the query at 806, process 800 can proceed to 808. In the event that it is determined that the local index information is not responsive to the query at 806, process 800 can proceed to 810. At 808, a local search result is obtained. For example, in the event that the application unit corresponding to the query information has been looked up in the local index information, process 800 can proceed to 808. Conversely, if an application unit corresponding to the query information has not been looked up in the local index information, process 800 can proceed to 810.

At 808, a local search result is obtained. The local search result can correspond to a search result of a query run against the local index information. The terminal can obtain the local search result. For example, in the event that the local index information comprises information responsive to (e.g., matching) the query (e.g., the query information), the local search result can be obtained. The obtaining of the local search result can include identifying, or otherwise determining, information (e.g., application units) in the local index information that is responsive to the query.

The local search engine finds unit information matching the query information in the local index information and regards such unit information as a search result.

At 810, the query is communicated for searching of the web index information. For example, the query can be communicated to a server associated with the web index information or a server associated with a web search engine configured to run queries against the web index information. The terminal can communicate the query (e.g., the query information) or searching of the web index information. For example, a search request can be sent to a server or web service for looking up server-side web index information. The search request can comprise the query information. In some embodiments, the local search engine sends the query to the server or other web service.

In response to receiving the search request, the server or web service can process the query against the web index information (e.g., search for the query information in the web index information). Based on a result of the processing of the query (e.g., a search result), the web search engine can determine whether an application unit matching the query information can be looked up. For example, the web search engine can determine whether the web index information comprises information that is responsive to (e.g., matching) the query information. The search result can comprise application data and other information. The server or other web service can provide the search result to the terminal.

At 812, a web search result is obtained. For example, the terminal can receive the search result from the server or other web service. The search result can be the web search result corresponding to a result of the query run against the web index information. In some embodiments, the local search engine obtains the web search result (e.g., from the server or other web service).

According to various embodiments, upon failing to find locally an application unit corresponding to the query information, a local search engine sends the query information to a server-side web search engine (e.g., send a query to the server and the server can return the server index information nor the results associated with the query run against the web index information), causing the web search engine to use web index information to search for the query information. For example, a search request can be generated according to the query information. The search request is sent to a web search engine of a server. After receiving the search request, the web search engine acquires the query information from the search request and queries the web search index with the query information. The web search engine obtains unit information matching the query information and regards such unit information as the search result. The web search engine then communicates the search result to the local search engine of the terminal.

According to various embodiments, the search results (e.g., the local search results and/or the web search results) can comprise a PageLink.

At 814, unit interaction protocol information is obtained and the application unit corresponding to the unit interaction protocol information is determined. The unit interaction protocol information can be obtained based on the search results (e.g., the local search result or the web search result). The unit interaction protocol information can comprise a URI corresponding to the application unit. The URI corresponding to the application unit can be returned in search results, and the URI can be used in connection with determining the application unit to be run. As an example, the application unit corresponding to the interaction protocol information can be obtained by performing a look up against a mapping of unit interaction protocol information and application units. The application unit(s) having a unit interaction protocol information in the mapping that matches the unit interaction protocol information obtained based on the search results can be determined to be the application unit(s) corresponding to the interaction protocol information.

After the search results are obtained, a PageLink can be obtained based on the search result. The PageLink can be used in connection with determining the application unit and can use the PageLink as a basis for executing the application unit to provide service for the user. For example, the terminal can determine the PageLink and can use the PageLink to determine the application unit corresponding thereto. The terminal can then execute the application to provide a service (e.g., to the user).

At 816, service processes are called and an application unit is woken up (e.g., the application unit exits a stopped or frozen state and enters a running state). The application unit can be woken up based on a call to run the application unit. The service processes can be called based on the unit interaction protocol information. The service processes can be used in connection with waking up the app unit.

According to various embodiments, PageLink serves as a basis for calling service processes in a terminal device operating system. The service processes are used to wake the application unit (e.g., to run a Page instance).

According to various embodiments, the service processes comprise a dynamic service process and/or a static service process. The dynamic service process can be a Dynamic Page Manager Service (DPMS) service terminal for managing Page running instances. DPMS generally refers to a service process. A dynamic service process is dynamic and can manage an application run-time status (e.g., such as which page should be run). The static service process can be a Static Page Manager Service (SPMS) service terminal for managing Page running instances. SPMS generally refers to a service process. A status service process is static and can manage an application install and uninstall, etc.

Calling service processes according to the unit interaction protocol information, and using the service processes to wake the application unit can comprise: the dynamic service process calling the static service process to obtain the application unit; in the event that the static service process determines that the application unit is not present locally, the static service process downloads the app unit from an application center (e.g., an application center platform) and can provide the application unit the dynamic service process; and the dynamic service process can run the application unit and display the user interface corresponding to the application unit.

DPMS can call SPMS to acquire a Page. SPMS looks up the Page with PageLink. When SPMS fails to look up the Page locally, SPMS can send a request to Page Center. Page Center thus downloads the Page. After acquiring the Page locally or from the Web, SPMS sends the Page to DPMS. DPMS runs the Page and can display the corresponding UI based on the Page Cover of the Page.

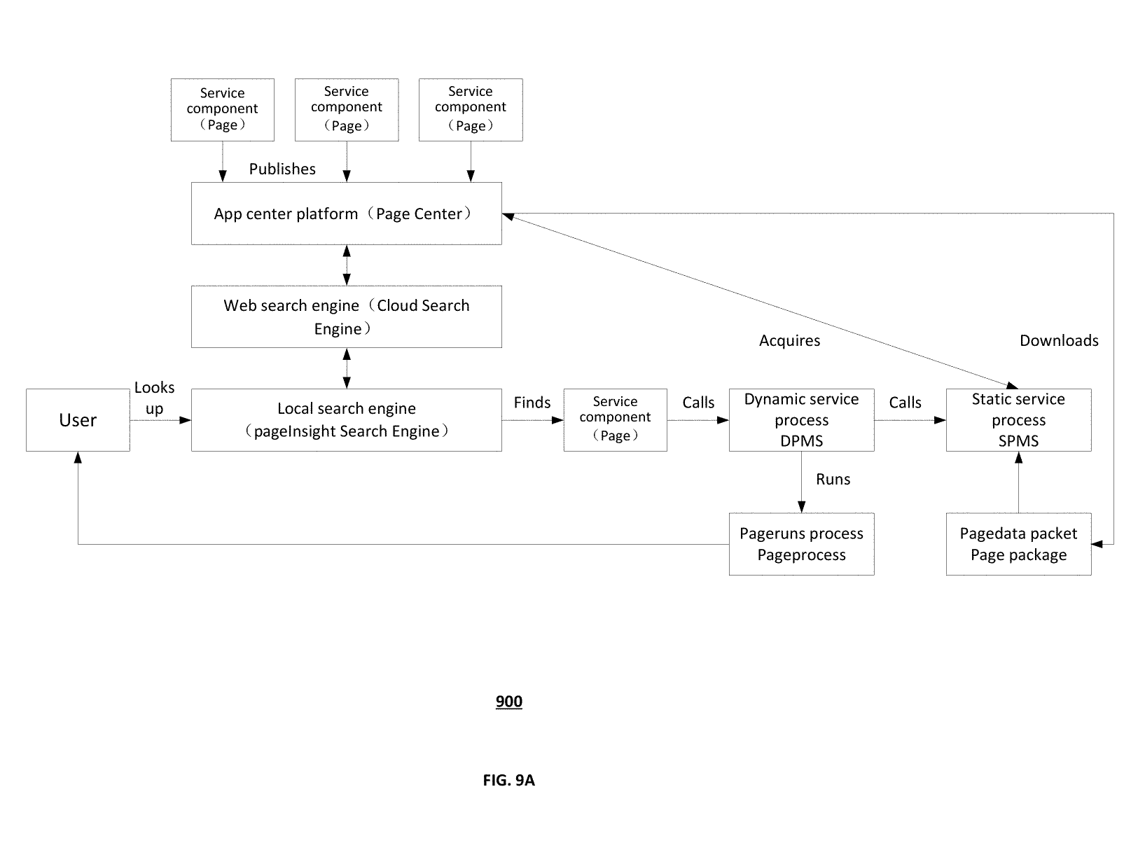

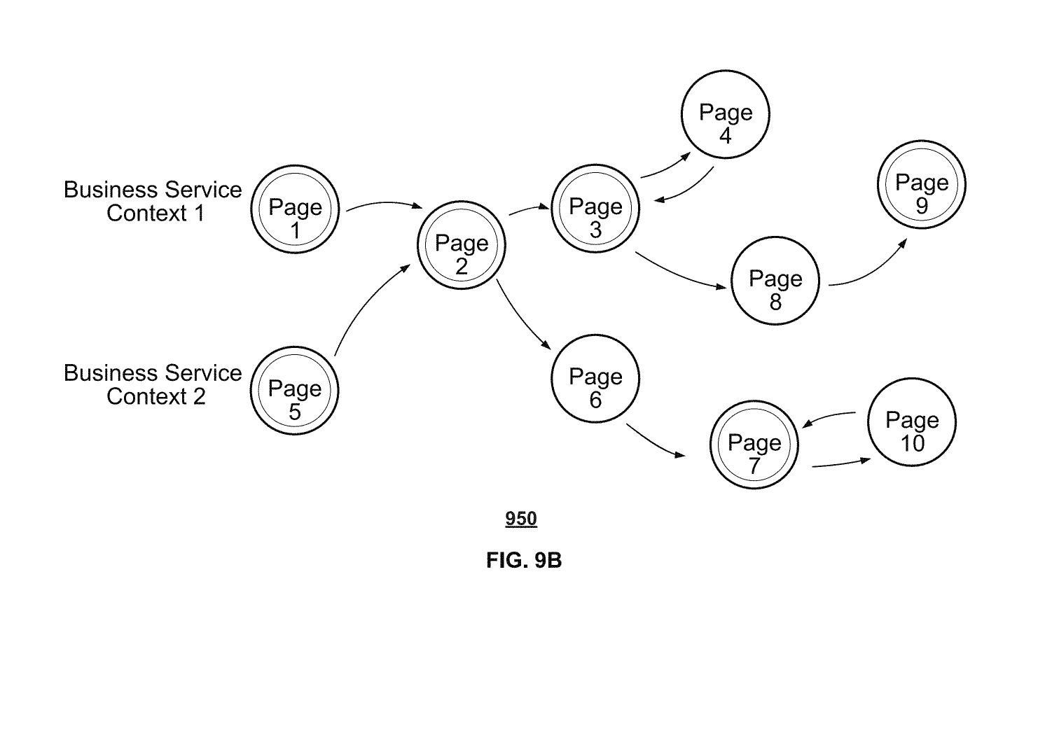

A search example based on the search method described above (e.g., process 800) is as shown in FIG. 9A.

FIG. 9A is a diagram of a search example according to various embodiments of the present application.

Referring to FIG. 9A, search 900 is provided. Search 900 can be implemented, at least in part, in connection with main framework 100 of FIG. 1 and/or main framework 200 of FIG. 2A. Search 900 can be implemented in connection with process 500 of FIG. 5, process 600 of FIG. 6, process 700 of FIG. 7, and/or process 800 of FIG. 8. Search 900 can be implemented by a system for performing search 400 of FIG. 4, terminal 1200 of FIG. 12, and/or computer system 1300 of FIG. 13. Search 900 can be performed by a client terminal or a server.

The local search engine can correspond to pageInsight Search Engine, the web search engine can correspond to Cloud Search Engine, and the application center (e.g., application center platform) can correspond to Page Center provided by OS. Pages can be uploaded to Page Center. Cloud Search Engine can create web index information based on Page Center. PageInsight Search Engine can create local index information based on applications and Pages in the terminal (e.g., installed on the terminal). The terminal can download Page data packets (package) from Page Center or store the Page data packets (e.g., the terminal can install applications corresponding to the Page data packets). Upon downloading the Page data packets or in the event that the terminal locally stores the Page, the terminal can locally run the corresponding Page.

The user can perform a search on the terminal. For example, pageInsight Search Engine receives the query information input by the user, or otherwise associated with the query requested by the user. The pageInsight Search Engine determines, either locally or with the Cloud Search Engine, the Page responsive to the query information and then calls DPMS to run the Page. DPMS acquires the Page from SPMS. If a Page package is present locally on the terminal (e.g., on a local magnetic disk), then SPMS acquires the Page locally. If the Page does not exist locally on the terminal, then SPMS acquires the Page from Page Center. The Page is then delivered to DPMS. DPMS runs Pageprocess (e.g., the page running process) and displays the appropriate user interface to provide the user with service.

FIG. 9B is a diagram of relationships between pages in a specific business service context according to various embodiments of the present application.

Referring to FIG. 9B, pages 950 are provided. Pages 950 can be implemented, at least in part, in connection with main framework 100 of FIG. 1 and/or main framework 200 of FIG. 2A. Pages 950 can be implemented in connection with process 500 of FIG. 5, process 600 of FIG. 6, process 700 of FIG. 7, and/or process 800 of FIG. 8. Pages 950 can be implemented by a system for performing search 400 of FIG. 4, terminal 1200 of FIG. 12, and/or computer system 1300 of FIG. 13. Pages 950 can be performed by a client terminal or a server.

According to various embodiments, various service functions are provided for the user on the basis of service components (Pages). A terminal can provide the necessary functions to the user (e.g., functions desired by the user) based on combinations of various Pages. DPMS can be the basis for transitioning from Page to Page and for running the corresponding Pages.

FIG. 9B illustrates Page relationships in two business service contexts. The Page relationships in two business service contexts are described in further detail below.

In a first business service context, a user operation on the UI for the business service in question triggers Page1 to generate a PageLink directed at Page2 and sends the PageLink via DPMS to Page2. After receiving the PageLink sent by Page1, Page2 processes and generates a PageLink directed at Page3 and sends the PageLink to Page3 via DPMS for processing. After receiving this PageLink, Page3 processes the PageLink and, on the one hand, generates a PageLink directed at Page4 that Page3 sends to Page4 via DPMS for processing. On the other hand, Page3 generates a PageLink directed at Page9 that Page3 sends via DPMS to Page9 for processing (Page9 is linked via Page8). After Page4 receives the PageLink, Page4 processes the PageLink and sends the processing result back to Page3.

In a second business service context, a user operation on the UI for the business service in question triggers Page5 to generate a PageLink directed at Page2 and sends the PageLink via DPMS to Page2. After receiving the PageLink sent by Page5, Page2 processes and generates a PageLink directed at Page6 and sends the PageLink to Page6 via DPMS for processing. After receiving the PageLink, Page6 processes the PageLink and generates a PageLink directed at Page7, which Page6 sends to Page7 via DPMS for processing. After Page7 receives the PageLink, Page7 processes the PageLink and generates a PageLink directed at Page10, which Page7 sends via DPMS to Page10 for processing. After Page10 receives the PageLink, Page10 processes the PageLink and sends the processing result back to Page7.

For example, in a travel business context, the service functions of the involved Pages can include travel strategy services, airfare and hotel information services, payment services, weather information services, etc. Transitioning among various Pages (e.g., each of which provides a different service) allows for various kinds of functional services to be provided to the user.

For example, in a mobile device, an application that already exists locally on the mobile device could insert application data via addIndex into the pageInsight Search Engine. For example, a mobile device already has an app, Shopping APP1, installed. In the event that a user clicks open a women's apparel page, the web page address of the PageLink of the women's apparel page is inserted into the search engine. In the cloud, various apps or Pages split from the apps can be put into PageCenter. For example, Shopping APP1 is a cloud app. Shopping APP1 could regard each classification item, such as Mall, Supermarket, etc. as a Page and could be placed (e.g., uploaded) in PageCenter.

The cloud's Cloud Search Engine uses a crawler to collect PageCenter Pages and builds web index information for searching purposes. For example, the Cloud Search Engine collects Taobao's Mall Page from PageCenter using a crawler and builds web index information.

While using the terminal device, the user searches for one application (e.g., the user searches for Mall). If the system does not have the application corresponding to the user's search (e.g., Mall), the terminal device can call the pageInsight Search Engine to acquire a Page name and pageLink corresponding to Mall in Shopping APP1. If the system has the application corresponding to the user's search (e.g., Mall), then the pageInsight Search Engine calls sendLink from the Page manager, which sends a pageLink. Through the Page manager, DPMS and SPMS call the function getPageInfo. If SPMS does not have the Page or application, then the Page or application is downloaded from PageCenter (load). A page process can be used to wake the application process. For example, if Shopping APP1 is woken, then Shopping APP1 goes to a Mall Page (page). For example, Shopping APP1 could, based on a user's request, navigate to the women's apparel page within Mall.

Various embodiments use Page as the basic unit of applications. Accordingly, users can be provided service through Page nesting combinations without installing a specific application for a desired service. This technique requires less storage space on the client device, and offers greater flexibility to the app developer. Providing the service to the user without requiring installation of a specific application for the desired services simplifies the service process. To support system-layer searches, a plurality of applications on a terminal (e.g., every app on the terminal) can be connected for executing a search.

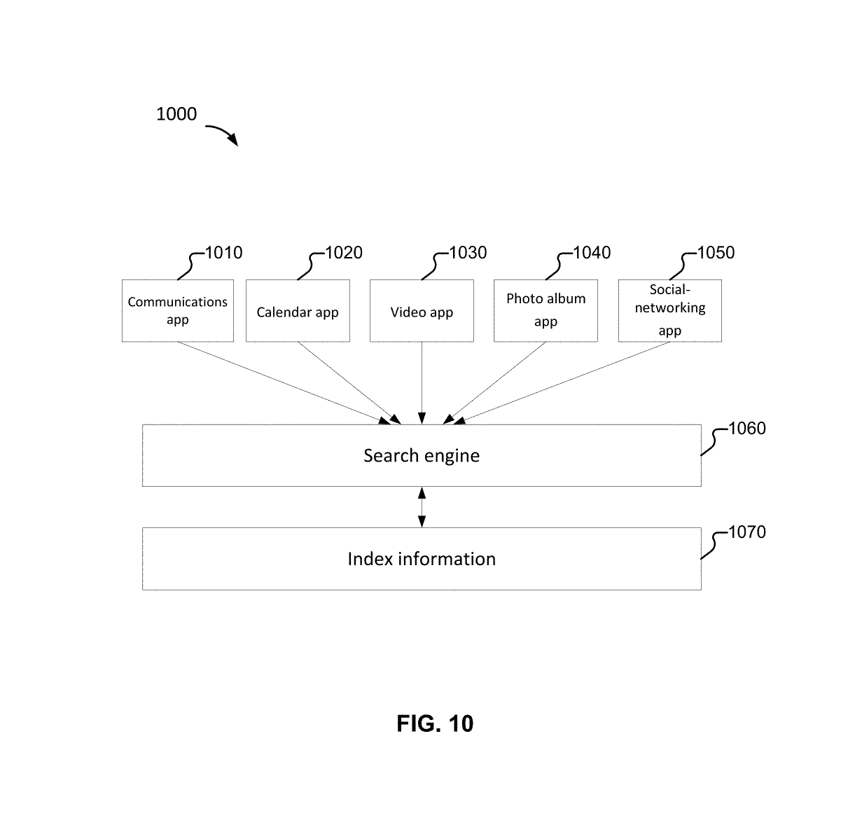

FIG. 10 is a diagram of a search example according to various embodiments of the present application.

Referring to FIG. 10, search 1000 is provided. Search 1000 can be implemented, at least in part, in connection with main framework 100 of FIG. 1 and/or main framework 200 of FIG. 2A. Search 1000 can be implemented in connection with process 500 of FIG. 5, process 600 of FIG. 6, process 700 of FIG. 7, and/or process 800 of FIG. 8. Search 1000 can be implemented by a system for performing search 400 of FIG. 4, terminal 1200 of FIG. 12, and/or computer system 1300 of FIG. 13. Search 1000 can be performed by a client terminal or a server.

As illustrated in FIG. 10, communication application 1010, calendar apps 1020, video application 1030, photo album application 1040, and social-networking application 1050 serves as data sources for search data. Search engine 1060 can use these data sources (e.g., data sources 1010-1050) to build index information 1070. The search engine 1060 can conduct searches based on the index information 1070. Other applications (e.g., instant messaging applications, etc.) can be used as data sources for search data.

Each application in the terminal adds application data to the search engine addIndex. Then the search engine creates index information (buildIndex) for the added application data. During a query, the query information, such as Chinese or Pinyin, could be subject to word segmentation. Thereupon, key words and other input information corresponding to the query information could undergo the smart search processing of queryParse to index the data needed, or requested, by the user and to give the search results according to the user's best matches. Thus, by connecting with the apps within a smart device, searching every application is possible.

Various embodiments can be applied to Internet of Things technology. Various embodiments can be implemented to be the control exercised by system devices within the Internet of Things over themselves or various embodiments can be implemented to be the control exercised over other system devices. Various embodiments can receive and integrate various system signals of the Internet of Things and then perceive the contexts of the system signals corresponding to searches and perform processing. For example, a search is to be performed on system signals from a lighting system and a security system in a household network and system signals from various kinds of smart home devices and smart kitchen appliances. The information described above may be acquired through the search engine of a server. For example, supposing a smart phone is used to monitor a household network, all the system signals in the household network can be sent to the smart phone. Then the smart phone is used to perceive the application contexts corresponding to the system signals and to perform distribution and processing. According to various embodiments, various application contexts can be developed for system signals. Various embodiments can integrate the application contexts of various devices and exercise control through the devices over themselves or other devices and thus build a unified development, control, management, and maintenance system platform suited to automatic execution of context needs.

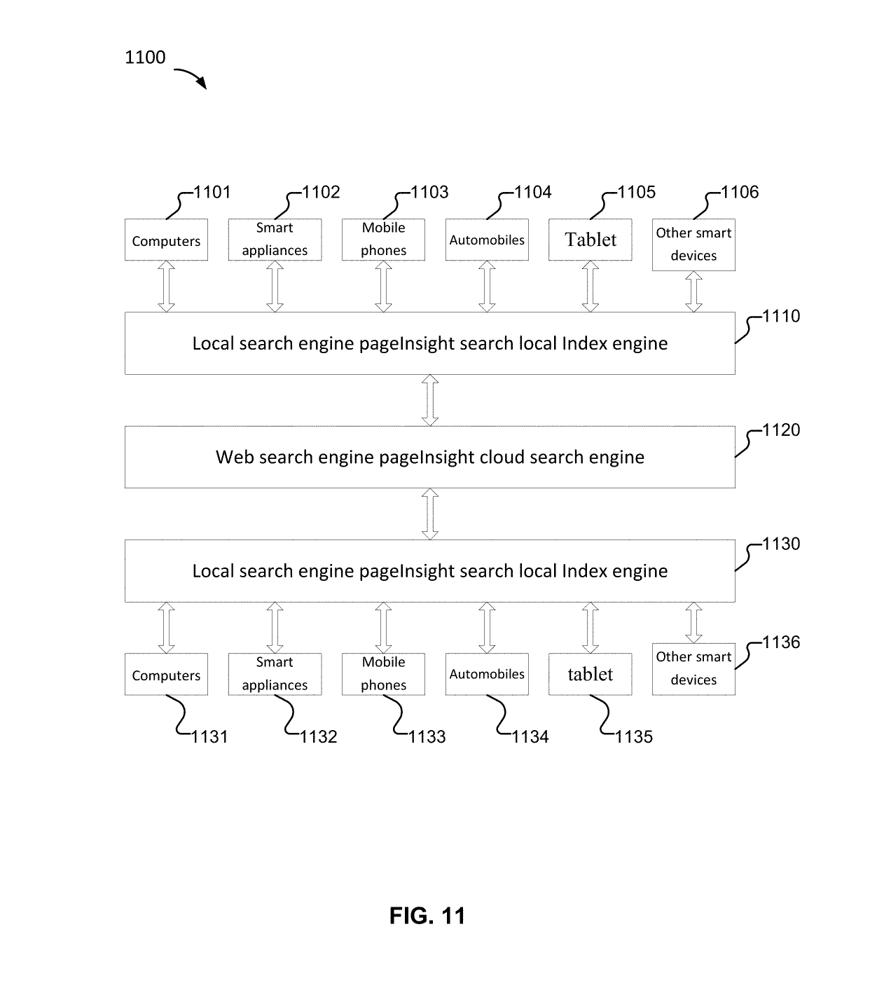

FIG. 11 is a diagram of a search example corresponding to an Internet of Things system according to various embodiments of the present application.

Referring to FIG. 11, search 1100 is provided. Search 1100 can be implemented, at least in part, in connection with main framework 100 of FIG. 1 and/or main framework 200 of FIG. 2A. Search 1100 can be implemented in connection with process 500 of FIG. 5, process 600 of FIG. 6, process 700 of FIG. 7, and/or process 800 of FIG. 8. Search 1100 can be implemented by a system for performing search 400 of FIG. 4, terminal 1200 of FIG. 12, and/or computer system 1300 of FIG. 13. Search 1100 can be performed by a client terminal or a server.

As illustrated in FIG. 11, a local search engine (pageInsight search local Index engine) 1110 can be set up within various Internet of Things smart devices such as computers 1101, smart appliances 1102, mobile phones 1103, cars 1104, tablet computers (pads) 1105, and other smart device 1106. Local search engine 1110 can connect to a web search engine (pageInsight cloud search engine) 1120.

The smart operating system of each smart device can have a local search engine (pageInsight search local Index engine). The applications in each device add application data to the local search engine (pageInsight search local Index engine) and then build an index for local searching. The local search engine and application center can also provide a cloud web search engine (pageInsight cloud search engine) with application data. A search index is built on the cloud and then all the Internet of Things devices are connected with the cloud to achieve true interconnection of Internet of Things devices so that Internet of Things devices can conduct seamless searching and devices can exercise mutual control. Thus, various terminal devices can be displayed as search results and implement terminal control.

A local search engine (pageInsight search local Index engine) 1130 can be set up within various other Internet of Things smart devices such as computers 1131, smart appliances 1132, mobile phones 1133, cars 1134, tablet computers (pads) 1135, and other smart devices 1136. Local search engine 1130 can connect to a web search engine (pageInsight cloud search engine) 1120. Local search engine 1130 can provide web search engine 1120 with application data. Local search engine 1110 can search application data provided to web search engine 1120 by local search engine 1130.

By registering direct account numbers (or other account identifiers or user identifiers) at the server, the user can bind various devices to the account numbers. Thus, a connection can be made to each device through the account number, and the application data can be uploaded to the cloud, enabling the cloud to acquire application data from various sources. Each device's connection to searches is strengthened by account number binding. When the user searches within a device, the user can perform input through various input modes including text and speech and thus call the data locally. Through unified account numbers and other user information, the data can be called by other devices, as well. By using account numbers and a search engine, other Internet devices request data from a cloud web search engine (pageInsight cloud search engine). Then the cloud web search engine (pageInsight cloud search engine) provides the search results. Thus, each device can search each other and provide users with various kinds of rapid and convenient service. By registering the direct account numbers at the server, the user can bind their own various devices with the account numbers, thus establishing a connection with each device. Moreover, the server can provide data, such as the various Pages, needed by the devices. When needing to control a device, the user can acquire the Page (page) of the appropriate function by directly logging in to the account and conducting a search. Thus, all of the user's devices can be connected and put under unified search control and management, which improves processing efficiency and user experience outcomes.

A device can be registered with the server in association with an account. For example, a user can register a device with the server in association with the user's account with the server (or service provided by the server). To register the device with the server, the user can establish a connection with the server, provide an identifier (e.g., a unique identifier) associated with the device to be registered (e.g., a MAC identifier, an IP address, etc.), and associate the identifier or device with the user's account. The user can be authenticated in connection with registration of a device. In the event that the user is authenticated in connection with the registration of the device, the user can submit a user identifier (e.g., login ID), and password, or the like. In some embodiments, the user logs into the server (or service provided by the server) using the device to be registered. In other embodiments, the user can register the device to be registered from another device. In response to receiving a request to register a device with the server (or service provided by the server), the server can store information associated with the device to be registered in association with the account (e.g., the user's account). The server (or the service provided by the user) can restrict visibility to application data provided by a device to only other devices that are registered under a common account (e.g., devices that are under a common subscription with one another).

According to various embodiments, a first device uses an application unit to generate operating information. The first device communicates (e.g., transmits) the operating information through a server to a second device. For example, the first device can control the second device based on the operating information. The first device can communicate the operating information to the server to control the second device. The server can translate the operating information to information that can be processed by the second device (e.g., to a protocol used by the second device). The first device and the second device can be Internet of Things devices. An Internet of Things device, by searching and running an application unit (Page), can display a user interface for that Page. In some embodiments, a Page can have functions to control other Internet of Things devices. The user can generate (or cause the terminal such as the first device to generate) operating information based on operations in the user interface. When the operating information requires execution of functions for controlling other Internet of Things devices, the operating information can be sent to the server. Then the server distributes the operating information to the corresponding other Internet of Things devices. After the other Internet of Things devices receive the operating information system signals, the other Internet of Things devices look up corresponding application units (Pages) based on subscription relationships. Then, PageLink can serve as a basis for waking the corresponding context apps (Context Agent). Context Agent Engine is used to manage the running of the context applications. The corresponding application units (Pages) found in Context Agent execute the operations for the application contexts. The server builds an index with app information collected from all Internet of Things devices, and the devices can be connected. It is possible through one device to control another device and achieve interconnection within the Internet of Things. Effective and rapid control is formed on the basis of seamless search and response.

Please note that all the method embodiments have been presented as a series of a combination of actions in order to simplify the description. However, persons skilled in the art should know that embodiments of the present application are not limited by the action sequences that are described, for some of the steps may make use of another sequence or be implemented simultaneously in accordance with embodiments of the present application. Secondly, persons skilled in the art should also know that the embodiments described in the description are all preferred embodiments. The actions that they involve are not required by embodiments of the present application.

FIG. 12 is a structural diagram of a terminal according to various embodiments of the present application.

Referring to FIG. 12, terminal 1200 for processing data is provided. Terminal 1200 can be implemented, at least in part, in connection with main framework 100 of FIG. 1 and/or main framework 200 of FIG. 2A. Terminal 1200 can be implemented in connection with process 500 of FIG. 5, process 600 of FIG. 6, process 700 of FIG. 7, and/or process 800 of FIG. 8. Terminal 1200 can be implemented by a system for performing search 400 of FIG. 4, and/or computer system 1300 of FIG. 13. Terminal 1200 can be implemented as a client terminal or a server.

As shown in FIG. 12, terminal 1200 comprises a processor 1210 and memory 1220.

The processor 1210 executes the computer code stored in the memory 1220 and thus implements the various data-processing methods described herein.

The memory 1220 is configured to store various kinds of data in support of terminal 1200 operations. Examples of this data include any app or method instructions, such as messages, pictures, and video, used for operations on the terminal device. The memory 1220 can comprise random access memory (RAM) and can also comprise non-volatile memory, such as at least one magnetic disk storage device.

Optionally, processor 1210 is set up in a processing component. The terminal 1200 may further comprise: a communication component 1230, a power supply component 1240, a multimedia component 1250, an audio component 1260, an input/output interface 1270, and/or a sensor component 1280. The components specifically contained within the terminal 1200 are set according to need. Various embodiments impose no limitations with regard to them.

The processing component 1205 generally controls the overall operations of the terminal 1200. The processing component 1205 can comprise one or more processors 1210 for executing instructions so as to complete all or some of the steps of the method described herein. In addition, the processing component 1205 can comprise one or more modules to facilitate interaction between the processing component 1205 and other components. For example, the processing component 1205 can comprise a multimedia module to facilitate interaction between the multimedia component 1250 and the processing component 1205.

The power supply component 1240 provides electric power to the various components of the terminal 1200. The power supply 1240 can include a power supply management system, one or more power supplies, and other components related to generating, managing, and allocating power to the terminal 1200.

The multimedia component 1250 comprises an output interface display screen provided between the terminal device and the user. In some embodiments, the display screen may comprise a liquid crystal display (LCD) or a touch panel (TP). If the display screen comprises a touch panel, the display screen may be implemented as a touchscreen to receive input signals from the user. The touch panel comprises one or more touch sensors to detect touches, sliding actions, and gestures on the touch panel. Said touch sensor not only can detect the boundaries of touch or slide actions, but also can measure duration and pressure related to said touch or slide operations.

The audio component 1260 is configured to output and/or input audio signals. For example, the audio component 1260 includes a microphone (MIC). When the terminal 1200 is in an operating mode, e.g., speech recognition mode, the microphone is configured to receive external audio signals. The received audio signals can be further stored in the storage device 1220 or sent by the communication component 1230. In some embodiments, the audio component 1260 further comprises a speaker for output of audio signals.

The input/output interface 1270 provides an interface between the processing component 1200 and peripheral interface modules. The aforesaid peripheral interface modules may be keyboards, click wheels, buttons, etc. These buttons may include but are not limited to: volume button, start button, and lock button.

The sensor component 1280 comprises one or more sensors and is used to provide status evaluations of various aspects of the terminal 1200. For example, the sensor component 1280 may detect the on/off status of the terminal 1200, the relative position of the component, and the presence or absence of contact between the user and the terminal 1200. The sensor component 1280 may comprise a near sensor, which is configured to detect the presence of a nearby object when there is no physical contact, including measurement of distance between the user and the terminal 1200. In some embodiments, the sensor component 1280 may further comprise a camera.

The communication component 1230 is configured to facilitate wired or wireless communication between the terminal 1200 and other devices. The terminal 1200 may access wireless networks based on a communications standard such as WiFi, 2G, 3G, or combinations thereof. In an embodiment, the terminal 1200 may comprise a SIM card slot. The SIM card slot is for inserting a SIM card, which enables the terminal device to register with a GPRS network and establish communication between the Internet and servers.

It is clear from the above that the communication component 1230, audio component 1260, input/output interface 1270, and sensor component 1280 can serve as an implementation of an input device.

According to various embodiments, communication component 1230, coupled to the processor, receives query information. The processor uses said query information to search index information and determines an application unit based on the search result. The processor can run the application unit.

According to various embodiments, the communication component, coupled to the processor, uses a web search engine to acquire application data from an application center platform, wherein the application center stores application units. The processor uses a web search engine to create web index information based on the application data so as to search for the application units with the web index information.

In another example, the operating system of terminal 1200 comprises: a context framework, a context analysis engine, and a context app layer. One example is a main framework applied to FIG. 1 described above, in which case the context framework is Context Agent Framework, the context analyzing engine is Context Agent Engine, and the context app layer is Context Agent Host.

Because the device embodiments are basically similar to the method embodiments, they are described in simpler terms. Refer to the corresponding section in a method embodiment as necessary.

FIG. 13 is a functional diagram of a computer system for performing a search or building an index according to various embodiments of the present disclosure.

Referring to FIG. 13, computer system 1300 for processing data is provided. Computer system 1300 can be implemented, at least in part, in connection with main framework 100 of FIG. 1 and/or main framework 200 of FIG. 2A. Computer system 1300 can be implemented in connection with process 500 of FIG. 5, process 600 of FIG. 6, process 700 of FIG. 7, and/or process 800 of FIG. 8. Computer system 1300 can be implemented by a system for performing search 400 of FIG. 4, and/or terminal 1200 of FIG. 12. Computer system 1300 can be implemented as a client terminal or a server.

As illustrated in FIG. 13, a computer system 1300 for processing data is shown. As will be apparent, other computer system architectures and configurations can be used to detect a specified identifier. Computer system 1300, which includes various subsystems as described below, includes at least one microprocessor subsystem (also referred to as a processor or a central processing unit (CPU)) 1302. For example, processor 1302 can be implemented by a single-chip processor or by multiple processors. In some embodiments, processor 1302 is a general purpose digital processor that controls the operation of the computer system 1300. Using instructions retrieved from memory 1310, the processor 1302 controls the reception and manipulation of input data, and the output and display of data on output devices (e.g., display 1318).

Processor 1302 is coupled bi-directionally with memory 1310, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1302. Also as is well known in the art, primary storage typically includes basic operating instructions, program code, data, and objects used by the processor 1302 to perform its functions (e.g., programmed instructions). For example, memory 1310 can include any suitable computer-readable storage media, described below, depending on whether, for example, data access needs to be bi-directional or uni-directional. For example, processor 1302 can also directly and very rapidly retrieve and store frequently needed data in a cache memory (not shown). The memory can be a non-transitory computer-readable storage medium.

A removable mass storage device 1312 provides additional data storage capacity for the computer system 1300, and is coupled either bi-directionally (read/write) or uni-directionally (read only) to processor 1302. For example, storage 1312 can also include computer-readable media such as magnetic tape, flash memory, PC-CARDS, portable mass storage devices, holographic storage devices, and other storage devices. A fixed mass storage 1320 can also, for example, provide additional data storage capacity. The most common example of mass storage 1320 is a hard disk drive. Mass storage device 1312 and fixed mass storage 1320 generally store additional programming instructions, data, and the like that typically are not in active use by the processor 1302. It will be appreciated that the information retained within mass storage device 1312 and fixed mass storage 1320 can be incorporated, if needed, in standard fashion as part of memory 1310 (e.g., RAM) as virtual memory.

In addition to providing processor 1302 access to storage subsystems, bus 1314 can also be used to provide access to other subsystems and devices. As shown, these can include a display monitor 1318, a network interface 1316, a keyboard 1304, and a pointing device 1306, as well as an auxiliary input/output device interface, a sound card, speakers, and other subsystems as needed. For example, the pointing device 1306 can be a mouse, stylus, track ball, or tablet, and is useful for interacting with a graphical user interface.

The network interface 1316 allows processor 1302 to be coupled to another computer, computer network, or telecommunications network using a network connection as shown. For example, through the network interface 1316, the processor 1302 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1302 can be used to connect the computer system 1300 to an external network and transfer data according to standard protocols. For example, various process embodiments disclosed herein can be executed on processor 1302, or can be performed across a network such as the Internet, intranet networks, or local area networks, in conjunction with a remote processor that shares a portion of the processing. Additional mass storage devices (not shown) can also be connected to processor 1302 through network interface 1316.

An auxiliary I/O device interface (not shown) can be used in conjunction with computer system 1300. The auxiliary I/O device interface can include general and customized interfaces that allow the processor 1302 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 13 is but an example of a computer system suitable for use with the various embodiments disclosed herein. Other computer systems suitable for such use can include additional or fewer subsystems. In addition, bus 1314 is illustrative of any interconnection scheme serving to link the subsystems. Other computer architectures having different configurations of subsystems can also be utilized.

The modules described as separate components may or may not be physically separate, and components displayed as modules may or may not be physical modules. They can be located in one place, or they can be distributed across multiple network modules. The embodiment schemes of the present embodiments can be realized by selecting part or all of the modules in accordance with actual need.

Furthermore, the functional modules in the various embodiments of the present invention can be integrated into one processor, or each module can have an independent physical existence, or two or more modules can be integrated into a single module. The aforesaid integrated modules can take the form of hardware, or they can take the form of hardware combined with software function modules.

Each of the embodiments contained in this description is described in a progressive manner. The explanation of each embodiment focuses on areas of difference from the other embodiments, and the descriptions thereof may be mutually referenced for portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, embodiments of the present application may employ one or more forms of computer products that implement computer-operable storage media (including but not limited to magnetic disk storage devices, CD-ROMs, and optical storage devices) containing computer-operable computer code.

In one typical configuration, said computer devices comprise one or more processors (CPUs), input/output interfaces, network interfaces, and memory. Memory may include such forms as volatile memory in computer-readable media, random access memory (RAM) and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital multifunction disc (DVD) or other optical storage, magnetic cassettes, magnetic tape or magnetic disc storage, or other magnetic storage devices or any other non-transmission media that can be used to store information that is accessible to computers. As defined in this document, computer-readable media does not include transitory computer-readable media, (transitory media), such as modulated data signals and carrier waves.

The embodiments of the present application are described with reference to flowcharts and/or block diagrams based on methods, terminal devices (systems), and computer program products of the embodiments of the present application. Please note that each flowchart and/or block diagram within the flowcharts and/or block diagrams and combinations of flowcharts and/or block diagrams within the flowcharts and/or block diagrams can be realized by computer commands. These computer program commands can be provided to the processors of general-purpose computers, specialized computers, embedded processor devices, or other programmable data-processing terminals to produce a machine. The commands executed by the processors of the computers or other programmable data-processing terminal devices consequently give rise to means for implementing the functions specified in one or more processes in the flowcharts and/or one or more blocks in the block diagrams.

These computer program commands can also be stored in computer-readable memory that can guide the computers or other programmable data-processing terminal devices to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data-processing terminal devices and made to execute a series of steps on the computers or other programmable data-processing terminal devices so as to give rise to computer-implemented processing. The commands executed on the computers or other programmable data-processing terminal devices thereby provide the steps of the functions specified in one or more processes in the flowcharts and/or one or more blocks in the block diagrams.

Although preferred embodiments of the present application have already been described, a person skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise said elements.

A search method, a method for building indices, a search means, a means for building indices, a terminal device, a server, and a terminal device operating system provided by the present application have been introduced in detail above. This document has employed specific examples to expound the principles and implementations of the present application. The above embodiment explanations are only meant to aid in comprehension of the methods of the present application and of its core concepts. Moreover, a person with ordinary skill in the art would, on the basis of the concepts of the present application, be able to make modifications to specific applications and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A search method, comprising:
obtaining, by one or more processors, query information;
searching, by the one or more processors, index information based at least in part on the query information, the index information comprising information that pertains to application units, wherein the information that pertains to an application unit comprises content of the application unit and Uniform Resource Identifier of the application unit;
determining, by the one or more processors, an application unit based at least in part on a search result; and
running, by the one or more processors, the application unit.

2. The method of claim 1, wherein the application unit is a service component to provide service functions.

3. The method of claim 1, wherein two or more application units can be combined and run.

4. The method of claim 1, wherein searching the index information comprises:
searching local index information based at least in part on the query information, wherein the index information is created according to application data of local applications.

5. The method of claim 4, further comprising:
in response to the application unit corresponding to the query information not being found in the local index information, communicating a search request to search web index information based at least in part on the query information, wherein the web index information is based at least in part on the application data obtained from an application center.

6. The method of claim 5, further comprising:
obtaining application data of a local application; and
sending the application data to a local search engine, wherein the local search engine creates the local index information based at least in part on the application data.

7. The method of claim 6, wherein communicating the search request to search the web index information based at least in part on the query information, in response to the application unit corresponding to the query information not being found in the local index information, comprises:
sending, by the local search engine, the query information to a server-side web search engine, and causing the web search engine to search the web index information based at least in part on the query information.

8. The method of claim 4, wherein the application data comprises: unit information of the application unit.

9. The method of claim 8, wherein the unit information comprises at least one of the following: application descriptive information, application address information, and unit interaction protocol information.

10. The method of claim 9, wherein the search result comprises:
the unit interaction protocol information, and the determining the application unit based at least in part on the search result comprises:
obtaining, from the search result, the unit interaction protocol information; and
determining the application unit corresponding to the interaction protocol information.

11. The method of claim 10, wherein the running the application unit comprises:
calling one or more service processes based at least in part on the unit interaction protocol information; and
waking up the application unit based at least in part on the one or more service processes.

12. The method of claim 11, wherein the one or more service processes comprise a dynamic service process and a static service process, and wherein the calling of the one or more service processes based at least in part on the unit interaction protocol information, and waking up the application unit based at least in part on the one or more service processes, comprises:
the dynamic service process calling the static service process to obtain the application unit; and
the dynamic service process running the application unit, and displaying a user interface corresponding to the application unit.

13. The method of claim 12, further comprising:
in the event that the static service process determines that the application unit is not present locally at a terminal, downloading the application unit over a network from an application center, and providing the application unit to the dynamic service process.

14. The method of claim 8, further comprising:
in the event that an application is running, obtaining the unit information corresponding to the application unit in the application;
deeming the unit information to be application data; and
providing the deemed application data to a local search engine.

15. The method of claim 14, further comprising:
in the event that the application invokes a user interface corresponding to the application unit, obtaining the unit information corresponding to the application unit.

16. The method of claim 1, wherein the obtaining the query information, searching the index information based at least in part on the query information, determining the application unit based at least in part on the search result, and running the application unit are performed by an Internet of Things system comprising a plurality of Internet of Things devices, the plurality of Internet of Things devices within the Internet of Things system interacting through search application units.

17. The method of claim 16, further comprising:
generating, by a first device running the application unit, operating information; and
communicating, by the first device, the operating information through a server to a second device to control the second device, wherein the first device and the second device are Internet of Things devices.

18. A method, comprising:
obtaining, by a web search engine hosted by a server connected to a network, application data from one or more application center platforms, wherein the one or more application center platforms store one or more application units; and
creating, by the web search engine, web index information based at least in part on the application data, wherein the web index information is searched for an application unit.

19. The method of claim 18, wherein the application unit includes a service component for providing service functions.

20. The method of claim 18, wherein two or more application units are combinable to run together.

21. The method of 18, wherein the obtaining of the application data from the one or more center platforms comprises:
collecting, by a crawler invoked by the web search engine, the application data of at least one application unit from the one or more application center platforms.

22. The method as described in claim 21, further comprising:
receiving a search request;
obtaining query information based at least in part on the search request;
searching the web index information based at least in part on the query information; and
providing a search result to a terminal.

23. The method of claim 18, wherein the application data comprises:
unit information of the application unit;
the unit information comprising at least one of application descriptive information, application address information, and unit interaction protocol information; and
the search result comprising unit interaction protocol information.

24. The method of claim 18, wherein the web index information is searched in connection with an Internet of Things system comprising a plurality of Internet of Things devices, the plurality of Internet of Things devices within the Internet of Things system interacting through search application units.

25. The method of claim 18, wherein before creating web index information based at least in part on the application data, the method further comprises:
obtaining, by the web search engine, the application data from one or more local search engines of one or more Internet of Things devices.

26. A device, comprising:
one or more processors configured to:
obtain query information;
search index information based at least in part on the query information, the index information comprising information that pertains to application units, wherein the information that pertains to an application unit comprises content of the application unit and Uniform Resource Identifier of the application unit;
determine an application unit based at least in part on a search result; and
run the application unit; and
a memory coupled to the one or more processors and configured to provide the one or more processors with instructions.

27. A device, comprising:
one or more processors configured to:
obtain application data from one or more application center platforms, wherein the one or more application center platforms store one or more application units; and
create web index information based at least in part on the application data, wherein the web index information is searched for an application unit; and
a memory coupled to the one or more processors and configured to provide the one or more processors with instructions.

28. A computer program product, the computer program product being embodied in a non-transitory computer readable storage medium and comprising computer instructions for:
obtaining, by one or more processors, query information;
searching, by the one or more processors, index information based at least in part on the query information, the index information comprising information that pertains to application units, wherein the information that pertains to an application unit comprises content of the application unit and Uniform Resource Identifier of the application unit;
determining, by the one or more processors, an application unit based at least in part on a search result; and
running, by the one or more processors, the application unit.

29. A computer program product, the computer program product being embodied in a non-transitory computer readable storage medium and comprising computer instructions for:
obtaining, by a web search engine hosted by a server connected to a network, application data from one or more application center platforms, wherein the one or more application center platforms store one or more application units; and
creating, by the web search engine, web index information based at least in part on the application data, wherein the web index information is searched for an application unit.
